(19) United States
(12) Patent Application Publication
(10) Pub. No.: US 2024/0417297 A1
(43) Pub. Date: Dec. 19, 2024

(54) Apparatus and Method for Biofilm Management

(71) Applicants: NEWhub Holding Company, Herndon, VA (US); Hampton Roads Sanitation District, Virginia Beach, VA (US)

(72) Inventors: Sudhir Murthy, Herndon, VA (US); Eugenio Giraldo, Robbinsville, NJ (US); Charles Bott, Virginia Beach, VA (US)

(21) Appl. No.: 18/820,333

(22) Filed: Aug. 30, 2024

Related U.S. Application Data
(63) Continuation-in-part of application No. 17/752,996, filed on May 25, 2022, now Pat. No. 12,077,460.
(60) Provisional application No. 63/192,719, filed on May 25, 2021.

(51) Int. Cl. C02F 3/12; C02F 3/10; C02F 103/20; C02F 103/22

(52) U.S. Cl. CPC C02F 3/1273; C02F 3/102; C02F 3/106; C02F 3/107; C02F 3/108; C02F 3/109; C02F 2103/20; C02F 2103/22

(57) ABSTRACT

The subject of this invention is to use beneficial reactive support media or biofilms in the form of reactive support bases or stratums that provide structural (including dimensions) or biochemical benefits to the growth or function (including agglutination) of biofilms. The functional aspect includes the provision of reactivity to a polymeric, cellulosic or silicic framework. The functions are supplied to the structural media during manufacture, conditioning, regeneration or during colonization of biofilms. The structural support media may include biodegradable or refractory polymers/plastics, alginates or uronic acids or extracted bacterial EPS. These materials are reacted, retained or removed based on their physical characteristics.

### CROSS-REFERENCE TO RELATED APPLICATION

This application is entitled to, and hereby claims, priority under 35 U.S.C. § 119(e) to U.S. Provisional Patent Application No. 63/192,719, filed May 25, 2021, titled “Apparatus and Method for Biofilm Management in Water Systems,” and U.S. Non-Provisional patent application Ser. No. 17/752,996, titled “Apparatus and Method for Biofilm Management” the disclosure of which is hereby incorporated herein by reference in its entirety.

### TECHNICAL FIELD

The present disclosure relates to methods and apparatuses involving reactive biofilms, including its manufacture, addition to a system, its maintenance in the system using physical forces, its removal using same or different physical forces, its replacement in the system, and its residual reuse within downstream systems. The system is any concept that uses water and microbiology including but not limited to manufacturing processes and any contained apparatus, drinking water production processes and any contained apparatus and water reclamation processes and any contained apparatus.

### BACKGROUND

Biofilms have been used in biological reactors (bioreactors), reactions, processes such as wastewater treatment for over one hundred years in many forms. These include suspended growth (including many different types of activated sludge), fixed media such as trickling filter in separate systems, and rigid or flexible plastic fixed biofilm support media in Integrated Fixed Film Activated Sludge (IFAS) systems (hybrid systems). Biofilms are also found moving on media in separate Moving Bed Biofilm Reactors (MBBR) and hybrid IFAS systems. These also include synthetic material like sponges or hard plastic carriers. More recently, biofilm support media have been developed with gas addition in the annulus, such as Membrane Aerated Biofilm Reactors (MABR). These biofilm support media are reactive using gases that provide a reactant to the microorganisms that comprise the biofilms. These reactive biofilms use membrane-permeable gases to improve the rates of reactions or to improve the energy efficiency of such reactions. A substrate or electron acceptor is fed to support such reactions. While these MABR systems are indeed reactive using gases, they are very difficult to implement because of the cumbersome support systems needed. A biological reactor or bioreactor or culturing reactor can host any biological organism or organisms (including but not limited to a virus, bacteria, archaea or eukaryote).

There remains a need to develop and/or manufacture structural reactive support media for biofilms and to then employ the physical characteristics that promote its use, its reactions, its selection, its removal and its final use.

### SUMMARY

Present invention provides reactive support media for biofilms or support media for reactive biofilms or reactive biofilms for any system or process (including industries and waste/wastewater systems) that provide the substrates or nutrients (including micronutrients) in the solid phase, and that help grow and select for microorganisms or their functions (such as enzymatic reaction rates, agglutination function, etc.), where solids phase support media are used to host, dope, affix, or deposit a functional reactant (by baking, coating, caking, sedimenting, impregnating, crosslinking or by any other means), or as a whole structural reactive particle biofilm support that enhance biological reactions or process functions in activated sludge processes (or in a bioreactor supporting active organisms as part of a manufacturing process or contained apparatus) or in the downstream processing of the wasted sludge, or the wasted (here the term wasted is used from a perspective of removing excess biological material which may include reactive support) solids/reactive support or discharged effluent. The support media for the solid phase deposition of a reactant as aforementioned could themselves be reactive or have thermal properties or inductive properties (such as using metals for induction heating). The structural biofilm support can be three dimensional (3D) printed as a part of a distributed or decentralized manufacturing process (using any polymers or substrates including biodegradable types). Other organic or inorganic substrates for printing or manufacturing by other means can also be considered including for example substrates that are edible for agro-industrial including livestock or aquatic animals (such as aquaculture) as an embodiment within a manufacturing process or contained apparatus. This printing/manufacturing can include simultaneous or subsequential deposition or inclusion of other reactants on surfaces or within micropores. Any of these manufacturing processes can involve the inclusion of air bubbles, pores or cavities to create any volume or shape including media or synthetic biodegradable sponges. The manufacturing process can include the doping of material to change the weight or specific gravity. The approach of replacement of these stratums or support media (upon exhaustion or sufficient exhaustion) is conceived including using replacement cartridges or modules or cassettes or cages or any form of replacement structure.

By being reactive and more specific to the desired microbiology, there is a tremendous potential to improve the treatment performance. Thus, the functional opportunity is to: 1) add reactivity to a support or have the support be made partially or fully of a material that is reactive, 2) add the structural reactive support to a process or reactor for biological growth, culturing or treatment, 3) the structural reactive support promotes the growth of certain microorganisms or confers morphological attributes, 4) the bacteria (or any other organism) have desired physiology or function essential for treatment within the—process or in downstream processes where they may migrate, 5) the treatment process has a more active inventory of desirable functionality, or 6) the treatment process has higher efficiency or can be operated at higher rates (intensification). One example embodiment of a microbial consortium is the activated sludge process. Other consortia examples include algae, fungi, protozoa or even higher lifeforms (such as plants, fish and other water dwelling organisms). The biological reactor that supports such consortia can further support higher lifeforms such as fungi, plants, or aquaculture that grow on the consortia, or in general culturing or water dwelling organisms to grow on the consortia. So, the higher lifeforms can either be part of the consortia or to grow on the consortia.

The reactivity conferred on the support is essential to confer function and the separation of the structural reactive support, the structural media, and modulating the amount retained or optionally sent to downstream process is managed based on reactivity maintained.

The structural reactive support media, the structural media, form the core or otherwise integrated in the biological material. The biological material could alternatively be included (within inclusions) within the structural reactive support. Higher active fractions of desired microorganisms result in improved performance of the reactor or process.

A support, a structural media, can be optionally first selected based on its specific gravity, charge, hydrophobicity, size, shear, compressibility or specific surface area. Additional reactivity can be added to appropriately change the specific gravity, charge, hydrophobicity or size. The reactivity could be baked in or soaked in, or chemically or physically grafted, or by blending (including being interlaced, comingled or integrated) different supports into one unit, or using any other approaches and then it is ready to be mixed into the biological process where it confers its attributes and overall reactivity. The reactivity can be added as a conditioning approach (such as a morphed physical attribute upon conditioning or introduced such as for ion exchange, sorption, hydrophobicity, etc.) The essential element is the reactivity of the support and/or the retention or removal of the support over time through modulating the efficiency or its retention or removal. In one embodiment, the manufacturing process and any contained apparatus include some pharmaceutical or agro-industrial (including but not limited to agriculture and aquaculture) applications selection of the support based on edibility is also considered.

The structural media is mixed into the biological reactor or process by either dropping it directly into a tank, or by adding it in a mixing tank containing the activated sludge or wastewater (one approach to conditioning). Over time, small amounts of structural reactive support are added intermittently or continuously, and small amounts are removed in the waste or effluent intermittently or continuously. The material in the waste or effluent are beneficial in the downstream process, and the amount of residual reactant may, if necessary, need to support these beneficial reactions.

The structural reactive support media, the structural media, can be used in water reclamation, water treatment or water reuse where biological treatment is used to remove constituent. It could be used in any part of the water reclamation, water treatment or water reuse where a biological reactor is present (including but not limited to suspended growth reactors, fixed film or hybrid reactors, fermenters, digesters, filters, sidestream reactors). It can be used to turn a reactor into a biological active reactor. It can be used for industrial wastewater including but not limited to agro-industrial wastewater treatment, such as water streams from/for agriculture, aquaculture and/or livestock industries. It can be used in any industrial or pharmaceutical manufacturing process. The support media can be used for manufacturing during treatment, for example, the invention can produce and help in the removal of products such as struvite, brushite, hydroxyapatite, vivianite, or any other chemical or element within a treatment or manufacturing process. Other products are also possible. It could help with growing products such as cultured microorganisms or enzymes or cofactors.

In an aspect the present invention provides an apparatus (100) comprising: a suspended growth biological reactor (110) with an inlet (111), an outlet (112), and an optional separator (113); a selector (116); and a structural media (10) having a single, multiple including interlaced, comingled or integrated, blended, or layered strata (20) that are fixed, suspended or moving, a functionalization of structural media (10) or biofilm (30); wherein the functionalization of structural media or biofilm enables the structural media to be reactive or have reactive properties from carrying a single or multiple biofilms of single or multiple solids residence times for selective growth of organisms or for removal of carbonaceous material, nutrients, inorganic compounds or micro-pollutants in a suspended growth process, wherein the functionalization is added to the structural media during manufacturing, during conditioning (pre-, insitu- or post-conditioning), during regeneration (such as for activated carbon or ion exchange), or introduced by the type of biofilm created by the shape of media or shear induced to produce the relevant reactive biofilm, and wherein a physical characteristic of specific gravity of the structural media obtained by functionalization is in the range of 0.45 to 2.4 configured for reactivity and sufficient retention so as to not be over buoyant or over heavy or with the ability to be resuspended or re-immersed upon sedimentation or floatation, for improved reactivity by enhancing mixing profiles and distribution, or for improved reactivity by promoting settlement or floatation and thereafter resuspension or re-immersion of contents within the biological reactor, and the selector (116) is configured to classify and remove the structural media by selection- or separation when the structural media has a change in specific gravity between 0.005 and 1.0, or change in particle size, between 10 and 1000 microns, and direct the removed structural media from the biological reactor to the downstream reactor for downstream processing. The structural media (10) along with the single or multiple biofilms (30): a. enables improved extracellular properties of the biofilm; or b. enables improved intracellular reactions within a microorganism; or c. selects for the growth of a microorganism or group of microorganisms; or d. inhibits the growth of the microorganism or group of the microorganisms; or e. enables improved structural characteristics within the biofilm; or f. enables increased reaction rates or confers strength or provides structure or function to the biofilm or the microorganism; or g. enables improved or provides ion exchange, negative or positive charge or polar or hydrophilic or hydrophobic characteristics; or h. provides inorganic carbon or alkalinity to manage biological reactions or substrate availability; or i. sorbs and retains constituents from the liquid; or j. enables improved nutritional qualities of an edible support; or k. enable improved removal or prevents the formation of greenhouse gases, including methane or nitrous oxide.

The structural media (10) comprises at least one of: a. inorganic or organic materials including plant derived or made with inorganic carbon; or b. silica or silicic materials; or c. metallic materials comprising one or more of potassium, calcium, magnesium, nickel, cobalt, iron, aluminum, copper, manganese, molybdenum or zinc; or d. biodegradable polymers/plastics; or e. recovered byproducts of wastewater or wastewater treatment process including both organic and inorganic inert or reactive materials; or f. metallic material is used as an intracellular or extracellular reactant for oxidation, reduction, electron transport, charge balancing or charge bridging; g. ion exchange material; or h. edible materials.

The single or multiple biofilms (30) comprises at least one of a bacteria, archaea or eukaryotes including algae or protists.

A reaction, regeneration or conditioning chamber 117 is added, and used in the apparatus, including for: a. enhanced regeneration of the ion exchange reactivity or activated carbon reactivity of the structural media (10) by chemical reaction; b. improved reactivity of pollutant using an oxidant or, reductant c. improved reactivity of substrates including pollutant by adding or removing an acid or adding or removing an alkali d. conditioning at least one structural media into water forming a water-structural media-slurry, mixing the water-structural media-slurry or removing undesired coatings, voids or bubbles from the media.

The reactor 110 or the downstream reactor 115 is an aquaculture reactor or livestock culturing facility or a feedstock production facility and the structural media is directed either from the physical selector 116, or from effluent 112 when optional solid liquid separator 113 is present or not present; or wherein the downstream processing include: a. within a sludge stream comprising either one or more of fermentation, crystallization, digestion, thermal hydrolysis, stabilization, stripping, thickening or dewatering, drying or thermal process; or b. within a liquid stream; or c. in a constructed process or a natural system comprising one or more of a wetland, a green infrastructure, a lagoon or a reservoir; or d. in an ecosystem selected from a lake, river, estuary, bay or a marine environment.

In the apparatus, one or more types of structural media of two or more different sizes or density, such that the smaller size or density pass through the selector 116 more quickly than the larger size and density that are retained, with each of the different size or density media with a different retention time within the system 100. The biological reactor is selected from an industrial wastewater treatment reactor including industrial aquaculture or industrial livestock production or processing, a high rate and contact stage, bio-adsorption reactor, an activated sludge reactor, a biofilm reactor, or a micropollutant biodegradation reactor that is used for water reclamation, or for producing potable or reuse water or for industrial manufacturing.

The physical characteristics of the structural media (10) are between: 10- and 100000-microns size for retention; or 10 and 10000 m2/m3 specific surface area for reactivity.

The structural media is a prismatic carrier 1100 designed to control biofilm depth and the geometric dimensions of said carrier are: D from 1-10 mm, H from 50 to 1000 μm, f from 0 to 1000 μm, d and d′ a fraction 0 to 1 of H, and h 0 to 1000 μm.

The selector is selected from one of a weight-based selector, a size-based selector, a compressibility-based selector, or a shear-based selector, including one of a lamella, a settling tank, a hydrocyclone, a centrifuge, a classifier, a mesh, a screen, a sieve, a filter, a membrane.

A system comprising two (2) apparatus, wherein a first apparatus 100-A and a second apparatus 100-B, with a shared structural media circulating between the two apparatus and the structural media separated in the selector of 116 of the first apparatus, 120-A, is returned to the second apparatus, and the structural media separated on the selector 116 of the second apparatus, 120-B, is returned to the first apparatus.

The first apparatus has at least one anaerobic zone and the second apparatus has at least one anoxic zone and the shared circulating structural media is preferentially directed from the first apparatus to an anoxic zone of the second apparatus.

In another aspect, the present invention provides a method comprises steps of: introducing an influent for a biological process; suspending a structural media in the biological process for reaction and use in the biological process, wherein the reaction and functionalization is provided by the structural media or by the single or multiple biofilm carried on the structural media for removal or consumption of carbonaceous material, nutrients, inorganic compounds or micro-pollutants in the influent, wherein a physical characteristic of specific gravity of the structural media is in the range of 0.45 to 2.4 configured for reactivity and/or sufficient retention so as to not be over buoyant or over heavy for improved reactivity by enhancing mixing profiles and distribution, or for improved reactivity by promoting settlement (and thereby as an example embodiment to allow for additional reaction time) or floatation (and thereby as an embodiment to remove pollutants) and thereafter resuspension or re-immersion of contents within the biological reactor, the physical characteristic is achieved through inclusion or removal of air bubbles, pores or cavities, or weighting material, or by a three-dimensional (3D) printing, moulding, extruding, doping, baking, coating, chemically grafting, cross-linking, caking, sedimenting, spray drying, solvent evaporation, irradiation or impregnating in manufacturing of the structural media, wherein the functionalization is added to the structural media during manufacture, during conditioning (pre-, insitu- or post-conditioning), during regeneration (such as for activated carbon or ion exchange), or introduced by the colonization of type of biofilm created by the shape of media or introduced shear to produce the relevant reactive biofilm; retaining or removing the suspended structural media by a classifying selector based on size or specific gravity of the structural media, wherein the selector classifies to remove the structural media by selection or separation when the structural media has a change in density or specific gravity, any value varying from 0.005 to 1.0 g/ml; or particle size, any value varying from 10 to 1000 microns. The structural media (10) comprises: inorganic or organic materials including plant derived, or made with inorganic carbon; or silica or silicic material; or metallic materials comprising one or more of potassium, calcium, magnesium, nickel, cobalt, iron, aluminum, copper, manganese, molybdenum or zinc; or
biodegradable plastics; or recovered byproducts of wastewater or wastewater treatment process including both organic and inorganic inert or reactive materials; or metallic material is used as an intracellular or extracellular reactant for oxidation, reduction, electron transport, charge balancing or charge bridging; or ion exchange material or activated carbon material; or edible materials.

The single or multiple biofilm (30) comprises at least one of a bacteria, archaea or eukaryotes including algae or protists.

The structural media or biofilm life varying in a range between 1 day and 10000 days or, wherein structural media or biofilm life of two or more different sizes is used, one that passes more rapidly through the selector and one that is retained in the selector, each size media with a different retention time between 1 day and 10000 days.

A reaction, regeneration or conditioning process is added to the method, and used including for: a. enhanced regeneration of the ion exchange reactivity or activated carbon reactivity of the structural media (10) by chemical reaction; b. improved reactivity of substrates including pollutants using an oxidant or, reductant c. improved reactivity of substrates including pollutants by adding or removing an acid or adding or removing an alkali d. conditioning at least one structural media into water forming a water-structural media-slurry, mixing the water-structural media-slurry, removing undesired coatings, voids or bubbles from the media or imparting functions including adding coatings to the media. The biological process is selected from an industrial wastewater treatment process, a high rate and contact stage process, bioadsorption process, an activated sludge process, a biofilm process, or a micropollutant biodegradation process that is used for water reclamation, or for producing potable or reuse water or for industrial manufacturing or an aquaculture process, or a livestock process or a feedstock manufacturing process. The physical characteristics of the structural media (10) are any a value between: 10- and 100000-microns size for retention; or 10 and 10000 m2/m3 specific surface area for use and reactivity. The selector is selected from comprising one of a weight-based selector, a size-based selector, a compressibility-based selector, or a shear-based selector including one of a lamella, a settling tank, a hydro-cyclone, a centrifuge, a classifier, a mesh, a screen, a sieve, a filter, a membrane.

### BRIEF DESCRIPTION OF THE DRAWINGS

FIG. 1 depicts the conceptual representation of the influence of structural reactive biofilm, base stratum reactivity, the structural media, in the bioreactions in the intracellular and/or extracellular matrix

FIGS. 2A-2C depicts different layering approaches for biofilm base stratums including a monolayer and bilayer/multilayer.

FIG. 3 represents application options for the proposed apparatus/process as a suspended biological treatment step with a solids liquid separation based on settling or clarification as applied to any manufacturing or treatment process (including water reclamation, water or biosolids reuse or drinking water production).

FIG. 3B represents two (2) of the proposed apparatus of FIG. 3, a first apparatus, and a second apparatus, and one (1) set of structural support shared between the two apparatus, and the structural support circulates between the two apparatus.

FIG. 3C is a further representation of the FIG. 3B concept where the biological process in the first apparatus has an anaerobic zone and the biological process of the second apparatus has an anoxic zone and the structural support circulates from the anaerobic zone of the first apparatus to the anoxic zone of the second apparatus.

FIG. 4 represents application options for the proposed apparatus/process as a suspended biological treatment step with a solids-liquid separation based on membrane separation as applied to water reclamation, water or biosolids reuse or drinking water production.

FIG. 5 shows an example representation of the impact of decreasing the thickness of the structural reactive base stratum (as it gets consumed) on its wasting or removal from the treatment system.

FIG. 6 represents various optional downstream solids processes where the base stratum can be used for additional reactivity or realized benefits including a fermenter, crystallizer, thickening, dewatering, digestion, thermal hydrolysis and/or side stream treatment. Some of these processes could represent the biological reactor for the stratum with a further associated downstream processing.

FIG. 7 shows the use of a base stratum, the structural media, containing a biodegradable polymer/plastic structural reactant.

FIG. 8 shows the use of biodegradable polymers/plastics surface reactant as a carbon source for denitrification and phosphorus removal.

FIG. 9 shows an approach where the physical characteristics of the structural media (10) are configured to allow the structural media (10) removal using the selection (116) based on an example weight-based selector based on change in specific gravity (for a fixed size of structural media).

FIG. 10 links the reactive supports with different specific gravity observed. For example, media such as granular activated carbon can have specific gravity greater than 1 but less than 2.

FIG. 11 shows an exemplary embodiment of one structural media 1100 designed to control the depth of the biofilm from very thin biofilms to thick biofilms enabling different reactivities (aerobic, anoxic or anaerobic).

FIG. 11B further illustrates an embodiment of the prismatic structural media 1100 for controlled biofilm depth where the optional stratum 1102 is further extended to the outside of the prism to further constrain and better define the protected volume where biofilm can grow.

FIG. 11C further illustrates exemplary alternative embodiments, as other exist, of the prismatic structural media 1100 with right prisms and oblique prisms and cup shaped.

FIG. 12 describes the essentials of FIG. 10 in a graphical format.

The present disclosure is further described in the detailed description that follows.

### DETAILED DESCRIPTION

The subject of the invention is the purposeful use of structural reactive biofilm support, a structural media, as a whole or as stratums (collectively called either stratum or base stratum) that improve 1) the rate of reaction of biological processes or 2) any other function such as agglutination or diffusion, or 3) preferentially select for certain organisms over others (similar to plating of specific organisms on agar but doing so in activated sludge or in any mixture containing liquid) using inhibitor and/or growth promoters or 4) providing morphological characteristics (size, density, compression, viscosity, etc.) that allow for their physical retention and/or physical removal when exhausted or sufficiently exhausted of their reactants such as based on their physical properties, such as size, specific gravity, shear or compressibility. This invention also supports the continued use of these structural reactive support stratum (support or stratum are used interchangeably) once discharged in the reactor waste stream or in the effluent, as the stratum moves through solids processing to improve chemical recovery processes (such as struvite, vivianite, brushite, hydroxyapatite) by for example providing suitable nucleation, deposition or reactivity sites, digestion processes by providing alkalinity or any other reactant (including cations, anions or oxidant or reductant), fermentation (such as acid or alkaline fermentation) processes, neutralization processes (acid or bases released) or dewatering processes (improve or decrease water holding capacity of biofilms through divalent cation bridging, or by removing water holding phosphates, or by providing physical structure (including and not limited to chemical influences such as charge, and physical forces such as hydrophobicity, Van der Waals force, etc.) for enhanced mechanical dewatering). Counter diffusion of substrates is possible to encourage the bacteria to seek internal substrates, thus growing inwards rather than creating filaments seeking substrates outwards. The downstream reactors or processes could be the biological reactors for the initial use of support stratum themselves, with further downstream processing downstream of these reactors.

The invention thus describes a multi-fold approach for providing reactivity through functionalization. This reactivity links to specific gravity based on the functionalization added. The functionalization can be added to the media during manufacture, the functionalization can be added by conditioning (pre-, insitu- or post-conditioning), the functionalization can be introduced during regeneration (such as for activated carbon or ion exchange), or the functionalization can be introduced by the type of biofilm (colonization) created by the shape of media to produce the relevant reactive biofilm.

An additional aspect of this invention is the use of edible supports as structural media in the context of biological reactors that can be use as feed for higher lifeforms including and not limited to plants (including hydroponic), livestock or aquatic organisms such as those grown in aquaculture installations, as part of a manufacturing process or contained apparatus embodiment. One example, as there are others, is the use of silicic support bases or stratums as structural media that can be discharged in the effluent once the overlayer structural reactive strata is consumed, where the silicic support is used to grow beneficial diatoms as a treatment byproduct and optionally use as feed to aquatic organisms. These organisms could be present or grown in the bioreactor or processed downstream. In one option associated with this aspect of this invention, these exemplary silicic support stratums are discharged as nanoparticles or microparticles to help with their absorption into the diatom or other organism analog's cell wall material. One additional option is to use a selection device to arbiter the overflow or discharge of these material as needed to grow the exemplary downstream beneficial freshwater or marine diatoms. Yet another example is the use of a carbonaceous edible feed material as structural media to grow a proteinaceous biofilm and use of the protein enriched support as feed for livestock or aquatic organisms. Growth of microorganisms in the biofilm with nutritious properties (any macronutrient or micronutrient) for aquatic life can be encouraged. An example of this application, as there are others, is the growth of biofilm rich in polyhydroxy alkanoates, PHA, known to be valuable nutritional supplements to aquatic organisms. Other growth factors are also possible (such as but not limited to fungal, algal or microbially produced materials including but not limited to docosahexaenoic acid (DHA), eicosapentaenoic acid (EPA), pharmaceuticals, antibiotics, supplements, proteins, carbohydrates, lipids, etc.). In the case of use or growth of specific species of organisms in the biological reactor, the influent or return streams may be subject to disinfection (such as ultraviolet, peroxide, ozone, chlorine, peracetic or performic acid, etc.), pasteurization or exclusion (such as using membranes) of contaminants or contaminating organisms.

The structural reactive support media, the structural media, can be media that is made of any material including polymer/plastic (preferably biodegradable), inerts, Styrofoam, organic, fabrics, etc. of any shape or dimensions, with the reactive agent blended, coated or inside the support, added or affixed during manufacturing or conditioning, that slowly is released through approaches such as dissolution, disintegration or it comes out. The support itself can be consumed if desired.

One important and crucial example embodiment is to make the structural media from any polymer/plastic (including natural or synthetic, biodegradable or non biodegradable) (including from 3D printed shapes). Biodegradable polymers/plastics are becoming an important material for manufacture of consumer goods and a route for its disposition is needed. There is soon likely to be a large supply of such polymers/plastics available as a solids phase carbon or nutrient source for micro-organisms especially if they are simultaneously beneficial to the organisms value in the market chain.

a. While the biology of such reactions are already a subject of interest, this embodiment considers the physical characteristics or factors crucial for the use of such structural media (including polymers/plastics) within reactors and systems, including the active surface area to volume ratio (also called specific surface area) for reactions (such as between 10 and 1,000,000 m2/m3 or greater), the porosity, shape factors, air bubbles to manage physical characteristics, the size and specific gravity. For example, structural media may range in size from 0.01 to 1.0 mm, or as much as 10 mm or greater (a range of 10 micron to 10,000 micron for use and retention), with a coefficient of uniformity of 1.1 to 1.7 and a variety of shape factors from 0.1 to 1, and porosity of 0.2 to 0.9. The specific gravity or density of the structural media is in range of 0.9 and 1.2, preferably with a broader range of 0.45 and 2.4 for use, retention and reactivity. The reactive approach is a feature of this invention that links the functionalization with specific gravity or size.

Another approach is to have these structural media converted into biodegradable textiles or sponges, with periodic replacement or removal of these materials upon sufficient or full exhaustion. Another approach is to have optical property to transmit light inside the structural media for use to grow organisms or for photoreactivity.

The inclusion of weighting material, heating material (such as heat wires, heat tapes, heating gases, heating liquids) or inductive material (such as metals) to change the physical, chemical or thermal properties of these structural media (including polymers/plastics) are also considered for both its maintenance and operation within a reactor or system, but also for its physical selection or removal (such as using a size, shear, compressibility, porosity, shape, or density separator, including but not limited to screens, filters, hydrocyclones, classifiers, lamella, settlers, floatation device, upflow device, airlift device, etc.) from the reactor or system.

The use of activated carbon or activated silica or any other support media are also a subject of the invention, either in pure form or multiple/blended (including being interlaced, comingled or integrated) with others forming a composite structural media. In one embodiment, the aforementioned activated carbon or activated silica could have multiple size ranges (such as granular and powdered) for facilitating different reactivities or reactions. For example, the granular size fraction (the fraction that is retained) could be used for biological activated carbon reactions (and as a structural media) while the powdered size fraction (fraction that in an embodiment passes through a physical selector) could be used for adsorption. In this manner a pollutant is comprehensively removed using these multiple size fractions in the same reactor or in a sequenced approach. An oxidant (including and not limited to ozone, ultraviolet, hydrogen peroxide, permanganate, or, any material producing radicals, including oxygen and hydroxyl radicals) or reductant (including and not limited to electron beam, hydrogen, or, any electron rich material) can be used in recirculation or influent or effluent stream to make a pollutant more labile for reactions or to disinfect to avoid contamination or both. A pollutant could be a small molecule such as hydrogen, methane or hydrogen sulfide or a large complex polymeric or heterogenous molecule.

Thus, the framework for using media and/or chemicals with functionality (sorption, charge, hydrophobicity/hydrophilicity) and use in a manner not to grow biofilms, but to remove pollutants or chemicals is proposed. These media are not biofilm structural support, and are maintained (or passed through) in the reactor either using a selector or a solid-liquid separator. The example of pass-through material is powdered activated carbon (that provide sorption) is one consideration. Other materials are possible. The complementary use of media is an embodiment of the invention.

Any consumable or biodegradable polymer/plastic can be used within the structural media including but not limited to bio-based polymer/plastics. The blend of precursors of biodegradable particles to be selected to control the physical and chemical characteristics of the carbon, element or compound released, or its fractional composition. The precursors or polymers used for production could be (and not limited to) as follows: polyhydroxyalkanoates (PHAs), polylactic acid (PLA), starch blends, cellulose-based plastic, lignin-based polymer composites, petroleum-based plastics, polyglycolic acid (PGA), polybutylene succinate (PBS), polycaprolactone (PCL), poly(vinyl alcohol) (PVA, PVOH), or polybutylene adipate terephthalate (PBAT). Blends of such polymers/plastics or any materials are also possible. In one example embodiment, blend of polymers/plastics with other materials that provide further reactivity to the structural media for ion exchange, or oxidation-reduction moieties for redox cycling, or increase sorption capacity, or increased enzymatic activity. These polymers can have enhanced or reduced reactivity for hydrolysis by increasing or decreasing surface area or any other biodegradation attribute such as but not limited to enzyme immobilization. The degradation can also be influenced by heat, redox cycling (between anaerobic, anoxic or aerobic zones), physical shear, etc. Once mobilized and made labile, the carbon can be stored internally as storage products by the microorganism or used immediately or sent to a downstream or upstream process as needed.

Any reactor type can be used including any upflow or downflow filter, including but not limited to slow or rapid (using biodegradable polymers/plastics instead of say sand/anthracite) type filters; fluidized bed (e.g., downflow, upflow, hybrid, expanded, or sludge blanket types), where the fluidizing velocity is selected to allow retention of the microparticle in the main vessel, hence proportional to the specific physical properties of the particle; packed bed (e.g., biofilter, tricking filter), where the particle size is selected to control system filter permeability to preferentially be >10 m3/m2 per hour, or preferentially be >1 m3/m2 per hour or preferentially be >0.1 m3/m2 per hour; mainstream or side-stream bioreactor (activated sludge, continuous flow, sequencing batch, batch or modified sequencing batch), alone (such as a chemostat, including and not limited to a fermenter, digester, etc.) or in combination with a separation vessel or device to increase the microbial concentration in the bioreactor as well as to recover the unused constituents of the growth media, with biomass concentration to preferably be >0.1% of the reactor volume or >1% of the reactor volume or >1% of the reactor volume, with the unused constituents of the growth media to be retained with an efficiency of >10%, or greater than 50%, or greater than 90%, or greater than 99%. In drinking water applications tanks and basins such as a flocculation basin, can include bioreactor functionality or be turned into a bioreactor by addition of reactive structural media presented in this invention. An hydroponic, fungiculture, algal-culture, or aquaculture basin can be considered a bioreactor (or a downstream bioreactor) for the purpose of this invention and reactive stratum with functionalization, or structural media, can enhance the biological activity. A bioreactor may be used to bio-augment the concentration of the microbial population in the contaminated fluid treated in the mainstream to achieve a removal of the pollutant(s) or interest to be greater than 5%, greater than 50%, greater than 90%, greater than 99%, greater than 99.9%, greater than 99.99%. Other multifunctional reactor with biodegradable polymers/plastics or other stratums carrying out more functions simultaneously, namely: solid carbon source, support for biofilm growth, or filtering medium to promote separation/treatment. Optionally used is a treatment system with self-regulating particle characteristics, e.g. increase of carbon release due to particle size decrease (the particle release being proportional to surface which goes up as the particle decreases in size, as well as the biofilm area goes up as the particle decreases in size). In essence, the use of biodegradable particles induced a proliferation of bacteria proportional to the square of surface area, since both carbon dissolution and m2 of biofilm both depend on a m2 of particles that increases as particle gets smaller. Once the stratum is sufficiently or fully exhausted, it can be optionally physically removed through a selector or chemically reacted away. Any residual activity can be used in a downstream process favorably.

In an important embodiment that provides for intensification, the use of structural media can convert a process/reactor that is mostly hydraulically (such as hydraulic retention time) driven (limited) to a mostly load (such as lb/d or kg/d) driven (limited) process/reactor. This allows for a higher load to be processed within a constrained hydraulic retention time, allowing for intensification of reactor or process (including any biological reactor/process such as a bio-adsorption reactor/process, any form of activated sludge reactor/process, fermenter, digester). Alternatively, for the same load, a higher flow (flow intensification) is also made possible for processing or treatment. In this case, the size of the biological reactor can be reduced. At least 10% flow or load intensification is estimated as a result of the use of such stratums, structural media, in this invention. The approach to intensification is by two means—improved solid-liquid separation and the ability to load the clarifiers, and the preferential uncoupling of specialized organisms on the reactive stratums based on the reactive mode (substrate, micronutrient, etc.) or based on the ability to be retained for longer solids residence times. For example, sorbed micropollutants on activated carbon can be the host for specialist organisms that degrade these pollutants. Ion exchange can also increase concentrations of a pollutant that is a substrate for organisms. For example, ammonia or nitrate that is exchanged onto a resin site can become a substrate for anammox or nDAMO (a denitrifying methane oxidizing organisms). Short chain fatty acids conjugated bases e.g. acetate or propionate, can become a substrate for methanogens, or for denitrifiers or for phosphorus uptake. Methane that is accumulated onto a selective media can also become a substrate for nDAMO. In another example nitrous oxide could be removed by a reactant and become a donor or acceptor for organisms. A micronutrient such as iron can be coated, sorbed or exchanged to allow for growth of organisms that use it as a micronutrient. All of this selection can help increase the microorganisms concentrations to then intensify the process. In one embodiment, the material can be the initial nucleation site for microorganisms and thereafter the organisms (as part of a reactive biofilm) is functionalized and can exist without the reactant on the stratum.

In one embodiment, these reactive stratums, or structural media, can load equalize substrates by behaving much like a capacitor, where at higher periodic loads (say diurnal), the sorbent or ion exchanger that is functionalized during manufacture, conditioning or regeneration, can remove a pollutant in excess, and this equalize the load removal by microorganisms that will uptake the pollutant at a more constant rate. This approach can stabilize processes that are subject to swings in loads of a pollutant or inhibitor, and these swings are moderated. As an example, ammonia could be removed by an ammonia selective media, and this removal by media increases or decreases with increase or decrease in load. The subsequent uptake of ammonia by ammonia oxidizing organisms at a moderated rate prevents the emission of nitrous oxide as a pollutant. In another example, the uptake of ammonia by organisms that do not produce nitrous oxide (such as anammox) can also reduce its emission. In any case, the capacitance of the reactive stratum to store and release a pollutant for microbial action is an embodiment of this invention. This capacitance can reduce toxicity, reduce inhibition, improve treatment or reduce the emission of greenhouse gases

In another embodiment, the longer solids residence time on the media or the diffusion characteristics, allows for the prevalence of organisms such as comammox that will reduce or eliminate nitrous oxide production.

In one embodiment, the functionalized reactive biofilm consists of denitrifying organisms and the complete reduction of nitrate or nitrite is promoted by managing carbon (C:N ratio). An increase in carbon to such biofilms will reduce nitrous oxide, especially in sidestream treatment. This could occur in anoxic zones (for consumption of oxidized nitrogen), anoxic periods (for consumption of oxidized nitrogen) or in simultaneous nitrification/denitrification (low dissolved oxygen) conditions.

In another embodiment of helping maintain a device performance associated with a limitation, such as hydraulic limitation (flow), is the add a dilution source (plant water or primary effluent or secondary effluent or any other fluid source) to manage this flow limitation associated with a size or density separator. If it is seen that the selector or separator is filling up with solids too much (and is becoming overly load limited), a dilution source is added to alleviate the loading and prevent washout. This is an important process safety embodiment of this invention, where a dilution source containing a fluid, manages and alleviates an overloading of a clarifier, lamella, screen or hydrocyclone of any form of solids (with or without contained reactive stratum). While this dilution limits the solids that are introduced to the separator or selector, it also prevents washout of solids as part of the separation or classification process. Thus the use of dilution to manage the separation or classification is an inventive approach where this dilution provides selective pressure for classification based on specific gravity or size.

In one embodiment, approaches to improve functionality or morphologies associated with the consortiums developed are part of the invention. These include any physical or chemical approach. For example, the use of chemicals such as chlorine peroxide or ozone (as an in situ functionalized conditioner), can not only oxidize or improve lability of the substrate, but can modify the morphology (such as for improved densification by removing filaments) or physiology (such as managing populations of organisms, including for example reducing or eliminating surface growing organisms such an nitrite oxidizing bacteria). A physical approach is for example, the use of hydrodynamic shear to develop unique functional reactive biofilm morphologies that for example help with the support of organisms or process is proposed. This shear can be applied at any location within the apparatus.

Material specification for structural stratums, structural media:

Physical: Biodegradable polymers/plastics (or any other structural media materials) micronized to have most of the particles preferably between 10 and 10,000 um to provide support for biomass growth as well as carbon source to heterotrophic organisms or symbiotically supporting autotrophic bacteria, the particles being manufactured to potentially have one or more of the following properties: 1) the surface to volume ratio of the printed (as an option) particle of arbitrary shape to be greater than an equivalent sphere containing the particle of arbitrary shape, that is, greater than the following formula: 4*pi( )*r\hat{ }2 divided by [4/3*pi( )*r3 or, upon simplification, greater than 3/r where r is the radium of the sphere of minimal volume (hence minimal radius) fully containing the particle, 2) the terminal setting or floating velocity of the printed (as an option) particle, to be greater in absolute terms of the terminal velocity of an equivalent spherical particle that is, greater than the following formula: 2*r\hat{ }2*(ρ−σ)*g divided by 9η where r is the equivalent radius diameter, ρ is the density of the particle, σ is the density of the fluid and g is the gravitational constant, 3) the hourly rate of carbon release of the printed particle (as an option) to enable denitrification, to be preferably greater than 10 mg carbon per mg of influent nitrate (per hour) or greater than 1 mg carbon per mg of influent nitrate (per hour) or 0.1 mg carbon per mg of influent nitrate (per hour), or any other rate below or above these rates, 4) the hourly rate of carbon release of the printed (as an option) particle to enable nitrification, to be preferably greater than 10 mg carbon per mg of influent ammonia (per hour) or greater than 1 mg carbon per mg of influent ammonia (per hour) or 0.1 mg carbon per mg of influent ammonia (per hour), 5 the hourly rate of carbon release of the printed particle to enable nitrification, to be preferably greater than 10 mg carbon per mg of influent orthophosphate, per hour or greater than 1 mg carbon per mg of influent orthophosphate or 0.1 mg carbon per mg of influent orthophosphate, 5) the hydraulic residence time of the printed (as an option) particle, to preferably be greater than 0.1 hour, greater than 1 hour, greater than 10 hours, greater than 100 hours or until the printer particles is fully dissolved, 6) the selective recovery of the printed (as an option) particle, to allow the printer particles to be preferentially recovered using attractive forces, repulsion forces, adhesion forces, electrostatic forces, the latter being augmented with materials selected to augment such forces (magnetite, iron particles, polar and non-polar substances, chemical surface modifiers).

The release of co-blended material purposely included in printed (as an option) particles to modify specific gravity, to be greater or lower than water by at least 5% but also many times that of water. The dissolution rate by induction or other forms of heating, to be greater of the standard dissolution rate at 20 C in tap water by at least 10%. The redox properties (for cycling of structural reactive stratums), to allow the development of redox-sensitive stratums and biofilms, and biomass with optimal growth condition between −600 to +300 mV, preferably greater than negative 600 mV, or greater than negative 60 mV, greater than negative 6 mV. Alternatively, redox properties could simply be classified as anaerobic, anoxic or aerobic. With redox properties being tuned or cycled using external energy or process conditions such as dissolved oxygen and temperature (from anoxic, anaerobic, aerobic) including using induced current controlled by induction systems or externally controlled via electrical and electromagnetic fields, light, pressure, shear, particle density, ORP/pH modifiers such as acid or base, etc. The separability by magnetic forces, enabled by the doping paramagnetic material in the particle, to be greater of at least 10% of the undoped particle. The release of micronutrients, enabled by doping micronutrients in the particle, to be greater by at least 10% of the micronutrient release of the undoped particle.

Biodegradable particles can contain chemical agents able to selectively growing biofilm with a specific microbial ecology on the particle, enabled by doping chemical agents in the particle such that the microbial population differs by at least 1% from the one growing on the undoped particle. Biodegradable particles can be manufactured with a 3D printer to optimize one or more of the physical properties indicated in the previous paragraph. Biodegradable particles selected from those with the unique characteristics of being degraded nearly completely (>50%) before leaving the treatment facility, hence with a degradation time (for 50% volume disappearance) to be lower particle retention time calculated from the point of addition of the particle until the location where the treated wastewater is discharged, this time being preferably shorter than 1 hour, shorter than 10 hours, shorter than 100 hours, shorter than 1,000 hours, shorter than 10,000 hours. Biodegradable particles to be used in combination of absorption (carbon-like) and ion-exchange (zeolite-like) material, either of natural or synthetic origin.

The volume fraction of biodegradable polymers/plastics to be selected based on the initial pollutant concentration and the hydraulic retention time of the pollutants to be removed and the rate of release of carbon. For example, for biofilters intended to denitrify secondary effluent that are fully nitrified should contain at least 30% of biodegradable particles such as pelletized polycaprolactone with an empty bed contact time longer than 11.25 minutes, 22.5 minutes, or 45 minutes, or 90 minutes. With the remaining volume being occupied by other particles able to perform different process function such as granular activated carbon (to sequester organic micropollutants and chemical oxygen demand), zeolite (to sequester ammonia), with relative amount dictated by initial pollutant concentration targeted by the media. For example, 30% volume in granular activated carbon for 20 mg/L of COD in the influent or higher, 30% of zeolite for 0.1 mg/L of ammonia or higher, and the reminder filled with biodegradable particles of polycaprolactone.

The biodegradable particles used in conjunction of carbon-like or zeolite-like particle in a sequential order dictated by the influent characteristics, or uniformly blended together; preferably, with a layer of carbon-like particle at the end of the biofilter to degrade any unused carbon released by the biodegradable particles, with such final layer being at least 10% of the total volume of the biofilter.

These structural support (structured media) materials can be used alone or as blend (including being interlaced, comingled or integrated), as well as augmented by selected chemical agents, as well as melted and re-molded as blend. Moreover, we can control the following factors to tailor their properties as ideal reactive medium for biofilm growth:

Chemical composition optimization can occur for these structured media in terms of resistance to biodegradation: n-alkanes>branched alkanes>low molecular weight aromatics>cyclic alkanes>high molecular weight aromatics=polar polymers.

These support media, structural media, can be retained in modules or cages or cassettes or between screens or other devices. For example, the cassette can be replaced as needed partially or fully with new media if and when it is (sufficiently) exhausted. Whereas the replacement or regeneration of the cassette or cages hosting the media can also be informed by one or more sensors placed to detect the biofilm reactivity. The media can also become smaller and escape the cage (made of bars or mesh) and get wasted and have additional downstream reactivity. The cage itself can be as small as a 1 feet linear internal dimension (for example use in 20 ft or 40 ft containerized systems), to exceeding 100 feet linear internal dimension. The volumetric shape of the cage can be a cube, cuboid, sphere, capsule, star, or any other shape that enhances treatment efficiency and dispersal of reactant within a biofilm.

The reactive biofilm support, structural media, in cassettes/cages can have a purposeful hydraulic flow regime of water or air, vertical to the cage (from top to bottom or bottom to top) or horizontal to the cage. The use of air or mixing to improve reactivity is envisioned by managing mass transfer considerations and the biofilm thickness.

In any case, any of these chemical reactive support media in activated sludge process can remain in a system or be removed using a physical selector device based on size, specific gravity or any other property such as compressibility, shear resistance, etc. The retention of these support media by a selector can be within (or internal to) the reactor (such as immersed cages with a mesh size) or using density/specific gravity (where the lighter material is surface wasted) or external to the reactor, in-line with the process or located with a waste stream. The selector can also be a hydrocyclone, screen, floatation, classifier, surface wasting, or any other device that can be used, as the support changes its composition and is ready for wasting or if the biofilm itself is ready for wasting. For example, the support (structural media surfaces) can initially be a size of 200 microns or a specific gravity (SG) of 1.05 and can be wasted when it becomes smaller (say 100 microns) or lighter (say SG=1.00). A change in particle size such as of 10 microns or of 100 microns or greater is conceived and a change in specific gravity such as of 0.05 g/mL or of 0.10 g/mL or greater is also conceived in this disclosure. Other specific gravity ranges and differences are also possible. One key aspect is to exploit the change in SG to the benefit of retention or removal. Same applies to size, viscosity, shear or other physical forces. The change in SG, size, viscosity or shear resistance is exploited to retain or remove. Thus, this allows a solids residence time management of the media and/or the biology that is grown on the media to any range value contained between say 1 day and 10,000 days (more typically between 1 day and 1000 days), or alternatively to a maximum of say less than 2 days, or less than 10 days, or less than 20 days, or less than 50 days, or less than 100 days or less than 1000 days or less than 10,000 days and so on. The exhausted media can be wasted or removed periodically based on SRT using the physical selection attributes/forces. The maintenance of these media in the tank can also be based on these physical attributes/forces. For the maintenance of these retained materials, the specific gravity or size of the material can also help with their ability to not be over buoyant or over heavy, thus allowing for improved mixing profiles and distribution within the reactor. This embodiment is important to help keep the structural media suspended and well mixed for enhanced reactivity in the biological reactor. A range of size or specific gravity is possible of the material (inclusive or exclusive of the growth burden). For example, the specific gravity of the media/material without growth could be more or less dense (such as 0.9 or 1.2) compared to after accounting for growth on this media (such as 1.1) to enhance mixing for improved reactivity. The range of specific gravity and size is larger if we want to improve distribution and yet to afford some floatation and sedimentation (again to enhance reactivity by affording this approach) within a reactor is between 0.45 and 2.4 g/ml, with a tighter range of between 0.9 and 1.2 g/mL for mixing. Another range in this embodiment includes a density/specific gravity of 0.8 and 2.0 g/mL and would be optimal for the range of material being considered herein for improved functionalization (example is resins and activated carbon that may be denser and hence heavier). All of these ranges support an approach of improving mixing profiles and distribution of material/media/stratum to manage buoyance and floatation for uniform retention, reaction or use in the biological reactor, with a mid-range (0.8-2.0) supporting denser reactive (functionalized) media with the largest range (0.45-2.4) supporting additional approaches for sedimentation and floatation within the reactor. The largest range as proposed herein will require more complex and expensive mixing devices or energy intensive mixing, and yet possible in the scheme of use, retention or reactivity in the biological reactor. Similarly, a range of 10 micron to 10,000 micron is herein proposed, again, to maintain a not too buoyant and not too heavy material/media/support/stratum within the biological reactor for optimal and uniform retention, reaction or use. The reactivity herein is introduced by either providing an approach to uniformly access the substrate, or to otherwise be available for preferred sedimentation or floatation Thus, as an included embodiment, an expanded specific gravity range of 0.45 to 2.4 (as well as the other ranges in this paragraph) for structural media (either with or without biofilm), is configured so as to not be over buoyant or over heavy for improved reactivity by enhancing mixing profiles and distribution, or for improved reactivity by promoting settlement (and thereby as an example embodiment to allow for additional reaction time by uncoupling the residence/retention time of forward flow from the sedimented solids) or floatation (and thereby as an embodiment to remove pollutants or as an embodiment to uncouple and provide additional residence/reaction time of flow from the floating solids) and thereafter resuspension or re-immersion of contents within the biological reactor, A lower or higher specific gravity than the largest range (0.45-2.4) would make the resuspension or re-immersion energy intensive and require extensive computational fluid dynamics modeling. An extremely heavy or light material would resist resuspension or re-immersion. The ability to use specific gravity (as part of Stokes Law) to manage reactivity (improving mixing/distribution for access to substrates or resuspension or re-immersion for improved reaction time) is herein disclosed. Some examples, include operating the biological reactor in an intermittent aeration/mixing (the stopping of aeration/mixing will make the media sediment or float) or low dissolved oxygen mode (the lower air flow rates will make the media sediment or float). In these modes, it becomes important to help the structural media maintain reactivity to oxygen supply or removing reactivity from oxygen supply (or to otherwise maintain suspension or to promote sedimentation when supply is stopped).

Use of natural plant-based material as structural media is desirable due to being renewable, having a relatively low cost, and being biodegradable, that is intrinsically reactive to biofilm. However, density of these materials is often too low to be able to be used as biofilm stratum directly, most of them float in water due to low density and if applied directly to a biological wastewater treatment process will result in large losses in clarifiers and carry over in final effluent. It is desirable to condition the support by adjusting its density to avoid losses and enhance settleability, or to condition the support by narrowing the particle size distribution, or to condition the support to improve functionality for different wastewater treatment applications, such as but not limited to phosphorus removal or nitrogen removal, or methane production, or to condition the support to modify its surface characteristics such as altering hydrophobicity or hydrophilicity. Conditioning the support by furthering its functionality is not limited to plant-based materials as the present invention also includes other materials different from plant-based materials.

Pre-wetting of plant-based structural media as a conditioning step to induce absorption of water within the material creates swelling of the plant material structure increasing its size and increasing density by displacing gas filled spaces with water. Pre-wetting in an exemplary embodiment is conducted in a tank filled with water and adding the plant-based material to form a slurry with induced mixing to force the low-density material to be in contact with water; air is also added in some cases to reduce the density of the fluid by forming a water-bubble mix, further enhancing the opportunity for the plant material to be submerged in water. Yet in other cases the plant-based material contains a waxy surface that renders it hydrophobic and reduces the ability of water to wet the material; in those case the use of an oxidant or a positive charge), such as but not limited to sodium hypochlorite or ferric chloride, is necessary to chemically condition or functionalize the carrier by adding and contacting said oxidant/charge with the tank slurry. An oxidant chemically reacts with the wax on the surface enabling water to wet and permeate the plant material. Yet in other cases conditioning is conducted by heating the slurry in the tank to solubilize and remove the waxy material. The functionalization (by removal) allows for the exposure of revealed surface for biofilm formation or reactivity. This approach to functionalization is an embodiment of the invention. Once the material has been water-saturated, usually in less than 24 hours, the slurry is blended vigorously with a homogenizer to optimize the particle size of the material. The homogenizer effect is controlled to obtain a settling velocity of the carrier within 1 and 10 meter per hour. This is done after material swelling to further control the hydrodynamic radius of the support and adjust the particle size, enhancing surface area, and settle-ability. These are example embodiments of conditioning for functionalization and specific gravity management.

A structural media, plant-based or otherwise, can also be conditioned by enhancing its functionality prior to introduction to the wastewater treatment process by coating the material with a biofilm in the slurry tank. Coating said support with a biopolymer or biofilm also enables selection of those support sizes with optimal settling properties prior to introduction to the treatment process as a slurry further minimizing the potential for losses (such as by abrasion). Biofilm coating is conducted in the slurry tank by seeding the system with desirable organisms such as but not limited to, fermenters, nitrifiers, methanogens, anammox bacteria, sulfate reducers, aerobic de-nitrifiers, and inducing growth of said organisms under controlled conditions in the slurry tank. Seeding of the slurry tank can be conducted also by bringing a seed of organisms from a wastewater treatment plant that has exceptional performance using supports further improving the ability to colonize the fresh support slurry in controlled condition prior to introduction. Addition of the biofilm-coated support also enables bio-augmentation of the wastewater treatment process in times of need. These coatings can adjust both specific gravity and functionalize the structural media.

Yet a further way of conditioning the structural media to induce reactivity by controlling density and further enhancing the support functionality for wastewater treatment is coating said supports, plant-based or otherwise, with iron oxides. This is conducted by adding ferrous iron (Fell) along silicates and calcium carbonate to the slurry tank where pre-wetted carriers are present. Aeration of the slurry will induce precipitation of iron on the surface of the carrier, coating it, enhancing its density and its ability to be used for phosphorus removal applications. Reduced manganese salts can also be added to the mix to induce a coating precipitate that enhances stability of the coating. This application for enhanced phosphorus removal is not limited to plant-based supports as other support materials, such as but not limited to, basalt, biochar, graphite, lignite, silica gel, fused silica, and other glass based material, would also benefit from coating with iron oxides.

To summarize, the subject of this invention is to use beneficial reactive support media, structural media, in the form of reactive support bases or stratums that provide structural or biochemical benefits to the growth or function (including agglutination) of biofilms. The functional aspect includes the provision of a cellulosic or silicic (or silica gel, silicates, or silicic acid or other silicon-based granules or particles) framework.

The framework could also contain charge moieties such as cations, anions, amines or carboxyl groups whose pKa's allow them to be charged at the physiological pH for an organism. For example, a cation may provide a positive charge to help the adherence of a negative charge exocellular polymeric substance. The reactive support media may include alginates or uronic acids or extracted bacterial EPS, for processes (such as a contact stabilization or A-stage reactor) that are EPS limiting.

In one embodiment of using charge and reactive structural media, an ion exchanger, and the inclusion of charged moieties enables ion exchange reactions for removal of ionic compounds, cations or anions, from the bulk liquid and enhancing contact with the microorganisms growing in the biofilm furthering degradation. Degradation of ionic species in the biofilm bioregenerate the ion exchange capacity further improving the process capabilities. Direct regeneration of ion exchange reactivity in the substratum is also considered as an option; in some embodiments this direct regeneration can take place in chamber 117. Anion exchange could include any anion, including but not limited to chloride or chlorine containing compounds, fluoride or fluorine containing compounds, bromide or bromine containing compounds, sulfate or sulfur containing compounds, bicarbonate, carbonate, carboxylate, or any anionic carbonaceous compounds (including organic acids and alkanoates), nitrate, nitrite, or any nitrogen containing compounds, phosphate or any phosphorus containing compounds, or, larger anionic carbonaceous or non-carbonaceous (including silicon containing compounds) macromolecules (such as with hydrophobic moieties). One example is to use a hydrophobic anion exchanger approach. In an embodiment, the exchanger could be a nutrient or substrate that is added to a biological reactor to replace a pollutant that is removed. For example, a chloride anion could be removed (to decrease the concentration of dissolved solids) by an ion exchanger for a bicarbonate anion that is an alkalinity (to improve pH) or desired inorganic carbon source for microorganisms. Another example is the replacement of hydrophobic pollutants such as perfluoroalkyl and polyfluoroalkyl substances with a desirable substrate such as polyhydroxy alkanoates or other biodegradable polymers. Other pollutant exchanges are also possible. In one other embodiment, hydrophobic or hydrophilic acids found in natural organic matter are removed (exchanged) with other anions or otherwise removed and bioregenerated. Yet another exemplary embodiment is the exchange of conjugated bases of short chain fatty acids such as acetate or propionate that are present in fermenter reactors or anaerobic bioreactors or fermentation cultures. These are just examples, and other exchanges of undesirable for desirable ions could also occur. In some cases, a large concentration of desirable material may be needed to exchange out a small quantity of undesirable material. Regardless of the ability (or inability) to add in desirable anions, the undesirable anion is removed. The ion exchanger can be bioregenerated within the reactor or regenerated external to the reactor. It could also be electrochemically regenerated.

In one embodiment, nitrate is exchanged for by bicarbonate, and the nitrate is then concentrated or reacted away using a denitrification reaction to nitrogen gas. Other exchangers are possible where nitrate or nitrite is exchanged for by chloride, etc.

The exchange of cationic materials is also possible. In an example of cation exchange, ammonia is exchanged onto an ion exchanger (that is then bioregenerated). The ammonia can become host to anammox organisms. The ammonia can be exchanged for by sodium in solution or regenerated externally. The zeta potential of the reactive structural media is preferably of positive charge to interact with negative charged matrix of extracellular polymeric substances in the activated sludge process. However, the charge can depend on functionalization and could be negative, neutral or positive, and can be measured as charge equivalents per unit mass or charge equivalents per unit volume. The charge density can also be assessed for the biofilm support. The charge in a stratum could also be amphoteric. The net charge equivalents is determined either using zeta potential or by charge titration. The functionalization of biofilm support could also have hydrophobic and hydrophilic moieties to confer zones for attachment of polar or non-polar materials for biosorption and removal. The hydrophobic and hydrophilic characteristics of a particle surface is determined by measuring the contact angle of liquid drops on that surface and can vary from 0 to 180 degrees. The functionalization of any plant-based or natural materials is proposed in the invention. This could include materials such as but not limited to hemp, jute, coconut or palm fibers, chitin, etc. Self-regeneration of function is a key part of the disclosure.

In one embodiment of the use of a reactive structural media is for the removal of organic anionic or cationic pollutants. These pollutants may first be concentrated into a solids stream before being removed using a reactive stratum. In an example, extracellular polymeric substances, humic or fulvic substances can be removed by anion exchange (a resin or a selective media that may contain a labile ion for exchange) or a coagulant that is on a stratum that destabilizes the substance. These substances tend to have, as an example, carboxylic groups (such as carboxylic acids including for example uronic acids). These carboxylic groups containing substances, in this example embodiment, are ion exchanged or charge neutralized on a site on the reactive stratum. These substances are then removed by the stratum and then exchanged out in a separate tank or selector for the introduced labile ion that was initially used in the ion exchanger for removing these substances. The removed substance (including EPS or humic material) can be used as a fertilizer and the labile ion can be used as a beneficial material in the bioreactor as one embodiment of this invention. In one specific example, the substances for exchange are extracellular or melanoidin material released by thermal hydrolysis and this material can be anionic (or with ability to coagulate, say by charge neutralization). A reactive stratum is used to remove this material either in the thermal hydrolysis process, a digester, a fermenter, or a sidestream process containing liquors from digestion. The ion exchange or coagulation using a stratum could occur in a separate reactor as well.

In one embodiment, chemical grafting can be functionalized to convey ion exchange properties to the surface of the structural media. Yet in other embodiments the surface of the reactive stratum can be directly grafted with small molecules of polymers with desirable functional groups or structures that can be covalently bonded using techniques such as but not limited to graft copolymerization, etherification, acylation to improve absorption capacity, absorption selectivity and/or adsorption kinetics. Examples of specific ligands are carboxylic groups, amine groups, alkyl groups, thiol groups, and special structures such as crown ether or cyclodextrin or EDTA.

In one embodiment, the charge or an ionic charge can be a functionalized feature of a control (such as using a zeta potential) to either manage substrates or manage media being added.

These preceding paragraphs provide embodiments of the use of charge as functionalization that conceptualized in the invention herein.

Other groups are possible in a functionalized anion exchanger (sulfate, nitrate, acetate, propionate etc.). Similarly, a cation exchanger of organic compounds is also possible, mostly ammonium, or an amine based organic molecules

Multiple layers are possible, including a base stratum consisting of for example a silicic or cellulosic or hemicellulosic or polysaccharides or carbohydrates (with or without amine or carboxyl moieties) material with coatings or impregnations of other chemicals (as a functional attribute) including metal ions or natural or biodegradable polymers or metabolites that help with the biological function (intracellular or extracellular) of the organism. The base stratum material could be plant derived such as jute, wheat straw, hemp or any material derived from agriculture product or residue. As the overlayers are consumed, the support media are removed or discharged to the waste or effluent optionally through a selector approach based on gravity, compressibility, etc. These support media can continue to provide benefits in downstream processes until they are completely exhausted of their function to help the biology or otherwise the reactor operations that support such biology. The sufficiently exhausted reactive surfaces can be wasted or removed periodically based on SRT using the physical selection attributes. The maintenance of these media in the tank can also be based on these physical attributes. Furthermore edible carbonaceous materials can be used as a stratum for biofilm growth enriching the edible support with proteins and metabolites with improved nutritional characteristics for aquatic organisms.

Some possible functional coatings or reactive deposits include the use of any one or more of the following metals, including copper, aluminum, iron, molybdenum, cobalt, zinc, nickel, calcium, magnesium and potassium. Other metal ions or rare earths are also possible.

The use of any functional metal, and in one embodiment key metalloenzymes or metalloproteins. Any of the above metals can be used by bacteria for the making or translation of proteins. For example, copper is key metal in the synthesis of ammonia monooxygenase and methane monooxygenase. These enzymes oxidize ammonia and methane, respectively in key reactions involving such substrates. Similarly, molybdenum is needed for nitrogen fixing genes and iron is needed in cytochromes and in the heme protein of many reactions. Other metal micronutrients are also possible and are within the scope of this approach.

Metal ions or compounds are also sometimes needed for charge balancing. For example, magnesium and potassium balance the polyphosphate or ATP charge. Any of the above-mentioned metals (and their ions or compounds) can be used for such purpose of charge balancing and is a subject of this invention.

Metal ions can also sometimes be needed for charge bridging. It has been shown that the use of calcium and magnesium is key for divalent cation bridging of negative charge associated with bacteria or the extracellular polymeric substances (EPS) and the coatings or deposits of such metals can be productive in such bridging. Iron or aluminum is also a key metal in the neutralization or coagulation of such charge in a floc or granule complex. The use of such metal ions can improve the compact structure of the biofilms and reduce bound and interstitial water and can increase particle density/specific gravity by removing entrained water in the floc, biofilm or granule. Any of the above-mentioned metals can be used for such purpose of charge bridging and is a subject of this invention. This concept can fall into biological reactions associated with the extracellular matrix.

Metal ions can be used to change the contact angle associated with surface to address hydrophobicity and make the biofilm more hydrophilic as needed for adhesion and for binding. Any of the above-mentioned metals can be used for such purpose and is a subject of this invention. This concept can fall into biological reactions associated with the extracellular matrix. The exhausted reactive surfaces can be wasted or removed periodically based on SRT using the physical selection attributes. The maintenance of these media in the tank can also be based on these physical attributes.

The redox state of some of these metals can be adjusted to improve their reactivity using oxidative or reductive reactions or alternatively to make them more catalytic. In some cases, a reduced metal is needed for the desired reactivity or oxidative properties, and in other cases, the metals are desired in their oxidized state for the desired reactivity or reductive properties.

The metals (cationic) or their compounds (including a counter anion) can be used alone (including as a cation or as an anion) or incorporated into any other particles, including but not limited to activated carbon, ion exchange materials, resins, biochar from pyrolytic processes and their combination. In one embodiment, the ion exchange material (either a cation or anion exchanger) is by itself or part of a blend (including being interlaced, comingled or integrated) or composite.

The use of functional organic substrates, metabolites, or surfaces for coatings or deposits are also possible. These substrates could be used directly as carbon sources under oligotrophic conditions such as for reuse or producing potable water or for the targeted purpose of catabolism or degradation of micropollutants or refractory microconstituents such as cyclic or phenolic compounds, cyclic ethers, dioxanes, furans, etc. present in water. For example, these substrates may help produce the appropriate enzymes needed for the degradation of certain pollutants or their daughter metabolites. Organic material can also be used for their charge characteristics at physiologic pH. For example, the amine, amide, carboxyl or hydroxyl groups can confer positive or negative charge supporting extracellular reactions/biology (in one embodiment, these include ion exchange). These groups could be associated with sugar, polysaccharides, proteins or glycoproteins including alginates and lectins. These organics could also include uronic acids. Other cationic, anionic (including as exchangers) or polar moieties can also be used. These extracellular charge or hydrophilic reactions can change the diffusion characteristics or the bound and interstitial water contained in the matrix that can support improved processing of the base stratum-biofilm complex. Such processing could include downstream crystallization, fermentation, digestion, stabilization, thickening or dewatering processes. In some cases where the organism is grown close to its maximum growth rate (near its log growth or just into its stationary phase), the organism may be flocculation limiting. In such cases, the supply of such compounds with negative charge, including bacterial or synthetic alginates or algins or uronic acids associated with base stratums could be useful for the extracellular matrix reactions and to promote flocculation.

The use of functional biological media is also possible, such as biologically reactive immobilized biofilms and their stratums as structural media. These biologically reactive media can be retained or excluded based on their physical characteristics such as specific gravity or size within for example gravity (including multiple times the forces associated with gravity) based, size based or shear/compressibility selection. The exhausted material can be wasted or removed periodically based on SRT using the physical selection attributes. The maintenance of these media in the tank can also be based on these physical attributes. These attributes are fortuitously synchronized with the attributes for use, retention or reactivity. Co-blending or pre-impregnation of selected strains of microorganisms or enzymes is also possible for any stratum.

The usages of functional inorganic minerals are also possible. For example, the use of silicic or inorganic carbon (such as carbonates) surfaces could encourage the build of rate limiting inorganics including for the production of beneficial diatoms that are part of the food web in both freshwater and saline ecosystems for combined grey-green treatment processes or for the use in downstream aquaculture, natural systems or constructed wetlands after the over-surface has been used in the activated sludge biology. These could be substrates for cell-walls or for chemoautotrophic processes. The use of graphene coatings are also contemplated for reactivity or for its physical characteristics.

Any of these above deposits could be applied as micro or nano particle deposits in a manner to improve lability or bioavailability within the bacteria. Processes could also be used to slow down the lability of the deposit or coating depending on the overall desired life of the coating or the base stratum. A mixture of chemicals within coatings could also be used. The coatings could also contain chelates or stabilizers as needed to help with desired reactivity.

The diameter of base stratums or surfaces can vary and could be as small as 10 microns and extend to 10,000 microns depending on purpose and downstream processing. The process of coating could involve mixing of an inert or near inert material in a pH adjusted solution followed by its filtering and drying. The coatings could include its reaction in an acid or base solution. The drying process could involve the use of heat or waste heat or heat exchangers or solar energy. The use of shakers and stirrers are also possible to improve reaction and mixing. The time constants associated with these steps could be as low as 30 minutes to 10 hours to over 24 hours in some cases. Baking processes could also be used.

The blending (including being interlaced, comingled or integrated) of layers of media is a consideration in preparing a composite stratum.

The use of recovered material from wastewater or wastewater treatment can be very attractive. For example, fibers and cellulosic material is often a waste product and could be employed or redeployed by adding coatings to them or using these recovered materials such as alginates or alginate-like substances as coatings. A waste or recovered product of one process could become a valuable base surface or reactive stratum of another process and this exchange of material in beneficial ways is possible. For example, there is a significant amount of organic inerts that are generated from screening of influent wastewater or biological sludge. These screenings can be coated with beneficial material and redeployed. Alternatively, these materials could include precipitates or crystals that could be useful within the biological process after some processing including pulverizing, grading or reconstituting is done on them. For example, alginate-like substances from activated sludge granules could be reused in an A-stage or contact stabilization process to improve flocculation.

The reactive stratum approach can be applied to, or included with, any type of activated sludge reactor, including, for example, a bioreactor and a clarifier, a sequencing batch reactor, a modified sequencing batch reactor, an integrated fixed film activated sludge reactor, an upflow reactor with integrated clarifier or decanter, a membrane aerated biofilm reactor, or a membrane bioreactor. Fixed, moving or mobile media as biofilms can be used if desired in any reactor configuration. The modified sequencing batch reactor can include a single or multiple reactor tanks in series, in a step feed configuration, with at least two sequenced clarifiers. The upflow reactor can include feed piping located at the bottom of the reactor with an integrated clarifier or decanter at the top of the reactor. In the figures, if an inlet or outlet is not explicitly shown for a reactor or a clarifier, it needs to be assumed to have such inlet or outlet. The purpose of the figure is to show the key embodiment for performing selection.

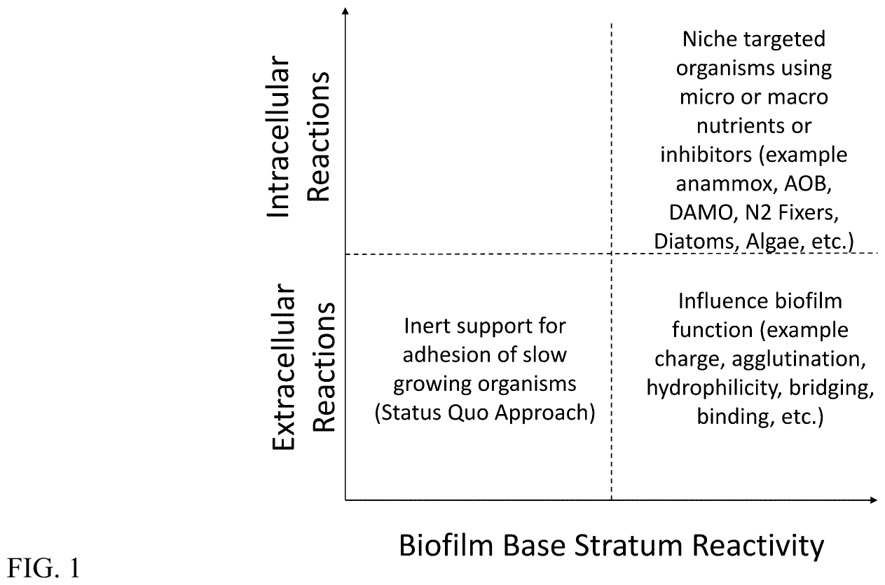

FIG. 1 depicts the conceptual representation of the influence of reactive biofilm base stratum reactivity in the bioreactions in the intracellular and/or extracellular matrix. Thus, the stratum can influence not only the intracellular growth or function of specific organisms or groups, but also the extracellular matrix necessary for their habitation. These extracellular materials can have important morphological and physiological features from charge properties, relative hydrophilicity, to quorum sensing. These features can impact their performance in a reactor or process and also the physical selection of the organisms. Examples of intracellular effects include growth or performance of targeted organisms using micro or macro nutrients or inhibitors (example organisms include anammox, AOB, DAMO, nitrogen fixers, diatoms, algae, fungi, etc.) in the reactive stratums. Examples of extracellular effects include influencing biofilm morphology or function (example charge, agglutination, hydrophilicity, bridging, binding, granulation, filaments, water holding capacity, etc.)

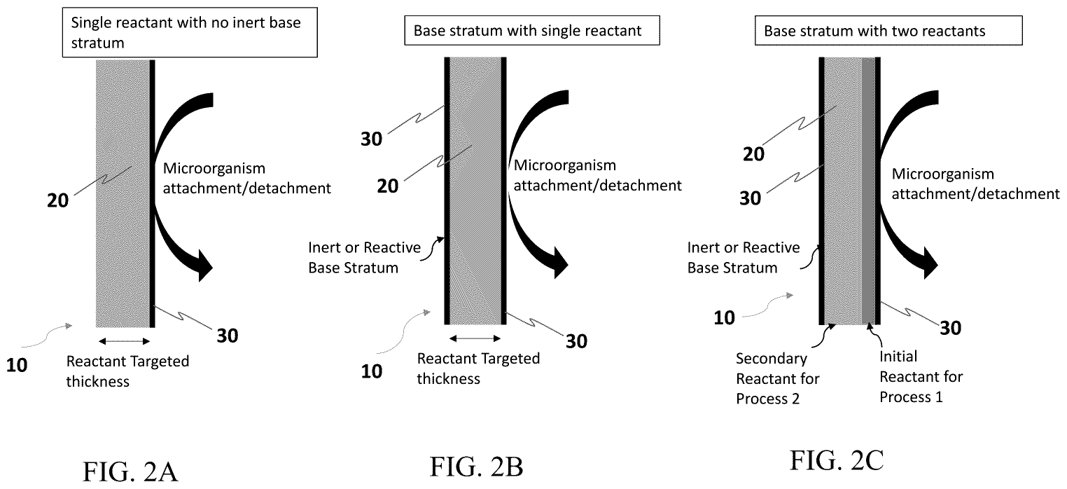

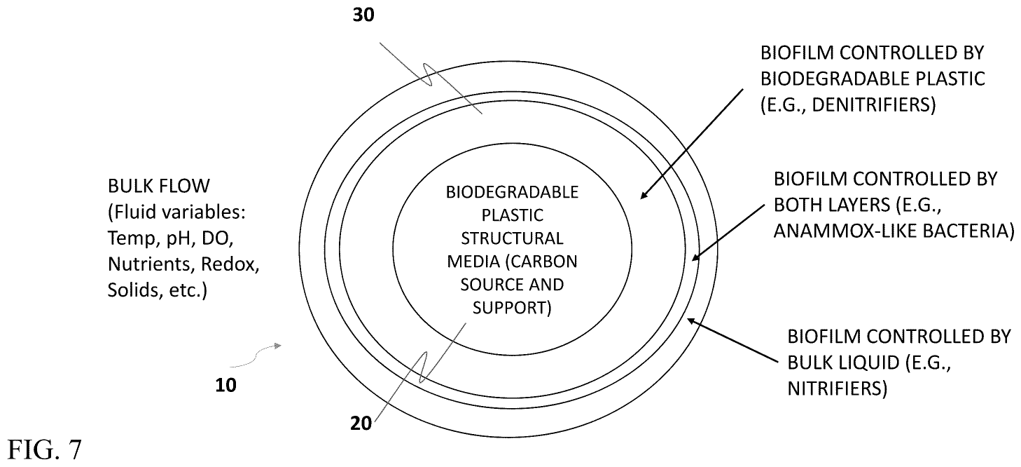

FIGS. 2A to 2C depict the structural media (10) that contain strata or stratums (20), that could optionally include an inert or reactive base stratum, and one more reactive layers where the layers themselves can be made of blended (including being interlaced, comingled or integrated) or composite materials. The layers can be uniform or non-uniform in structure or morphology. The strata will support one or more biofilms (30). FIG. 2A does not contain a base stratum but has a reactive support stratum (20) and a biofilm (30) as also shown in FIG. 7 for an example embodiment. FIG. 2B contains an inert or reactive base stratum and a single reactant layer (20), and a biofilm. FIG. 2C contains a structural media (10), with base stratum with multiple reactant layers (20) and a single biofilm (30). The media (10) or the biofilm (30) can be functionalized to be reactive. The microorganisms are contained in the biofilm and their attachment or detachment occurs naturally or using any physical forces such as but not limited to mixing, vibration, acoustics or aeration. The different layering approaches for structural media and biofilm stratums including base stratum (either inert or reactive), including a monolayer and bilayer/multilayer of any targeted thickness (including being interlaced, comingled or integrated as a blend or composite) that is related to its use, reactivity and desired life (its exhaustion) in the process or reactor and to have other effects in a carryover reactor or process. The base stratum (optionally by itself a reactant layer as in FIG. 2A) could also be reactive (such as biodegradable polymers/plastics, metals or silicic material, or edible material for culturing, including aquaculture applications and have a function by itself), and all these reactivities could be synergistic to grow desired organisms on biofilms (30) of series or parallel functions with similar or different redox related functionalities. The reactants could be for example growth promoters and/or inhibiters, used in a manner to select for organisms, functions or morphologies. These reactions and layers could be revealed in the biological process such as the activated sludge (such as process 1, and the reactant used for the process) or a downstream process (such as process 2, and a reactant used for the process) or a drinking water treatment process where reactive supports are added, or an aquaculture process. A single reactant can be used for multiple processes and multiple reactants can be used for a single process. Downstream process (such as process 2) could occur in the liquid or solids stream depending on the migratory destination of the structural media. A physical selector could remove or direct the structural media to downstream process. The selector could be a mainstream solid-liquid or solid-solid separator that is inline to the process or an external physical selector in the waste stream. Thus, multiple approaches to functionalize the structural media (10) or the biofilm (30) is herein revealed (and in subsequent figures). The function addition associated with the structure media could represent the stratum (20) as an embodiment, or the biofilm (30) as another embodiment, or in combination.

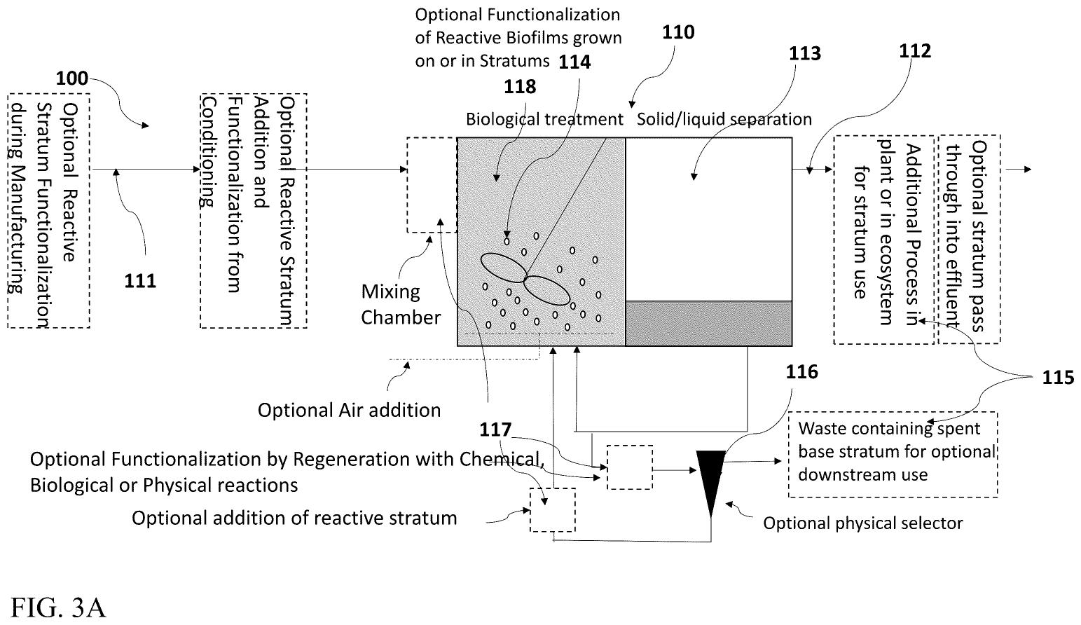

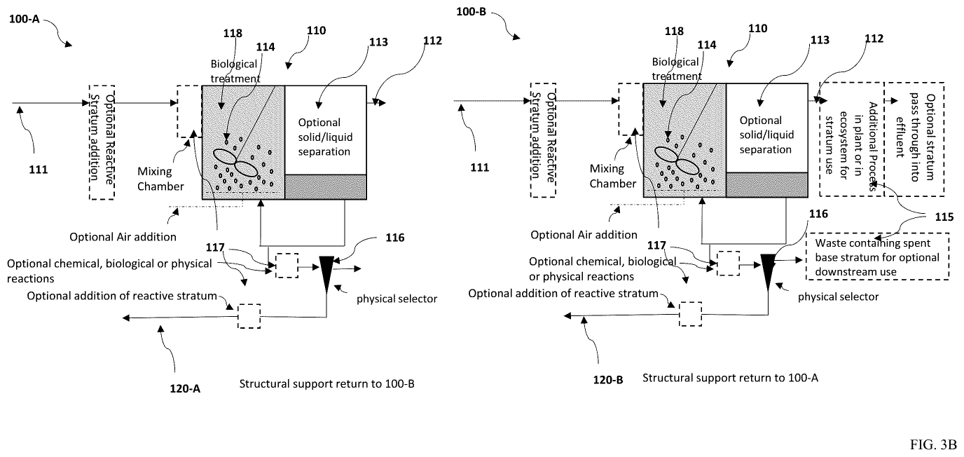

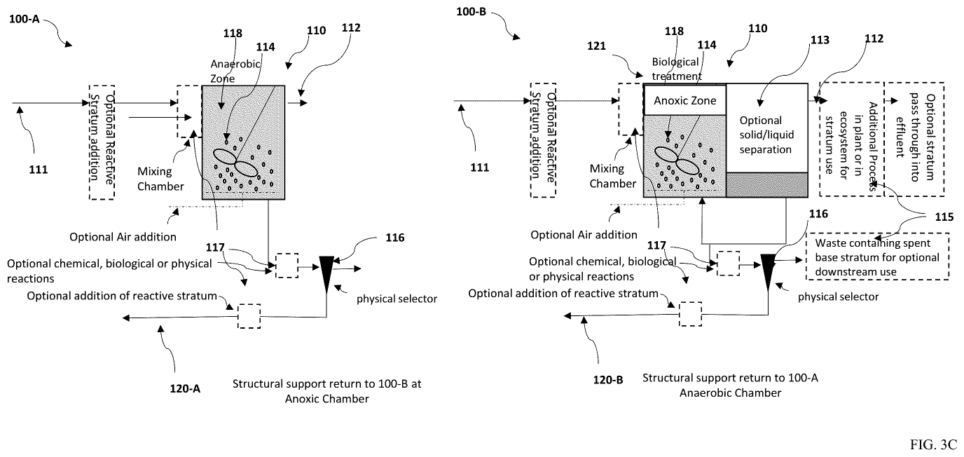

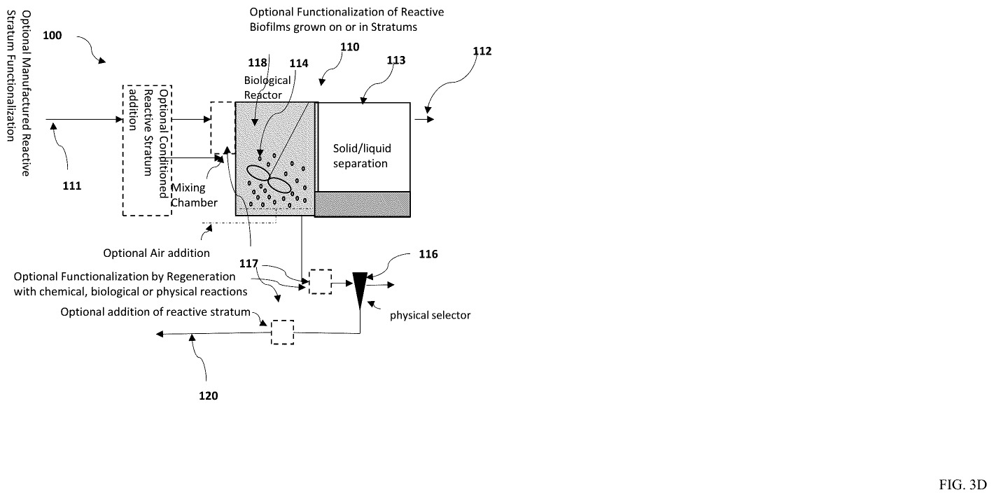

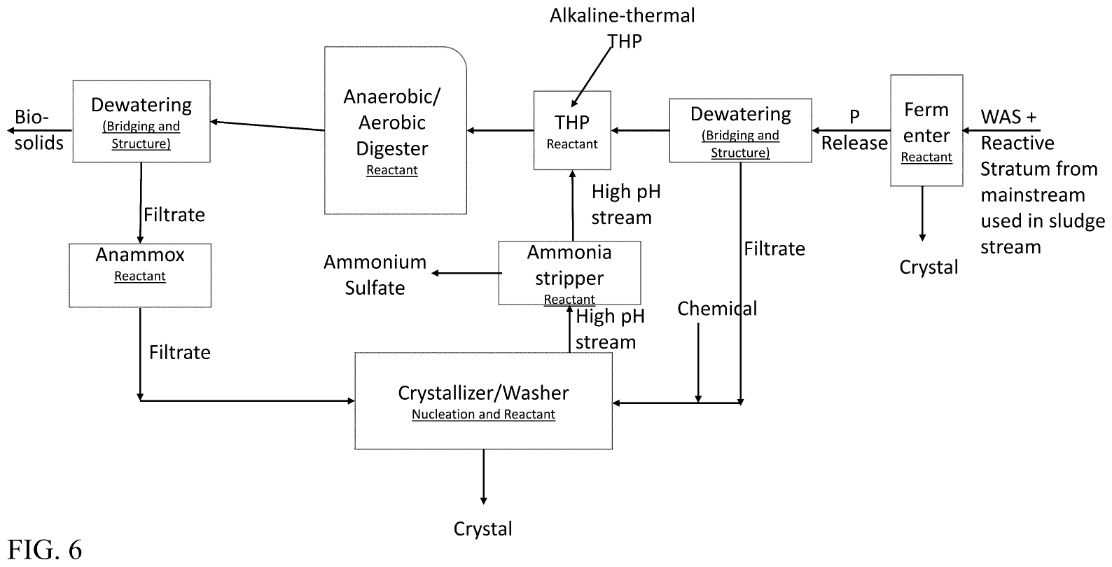

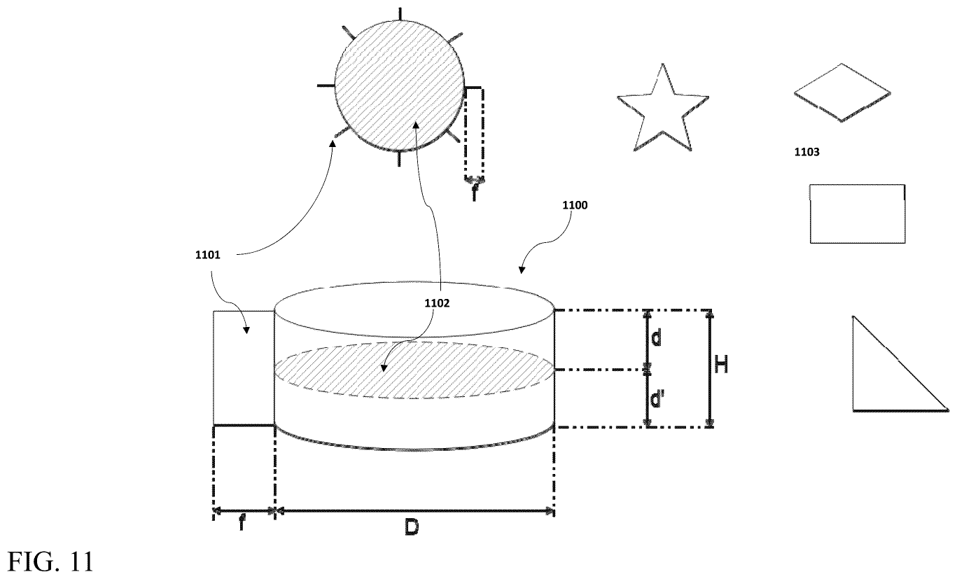

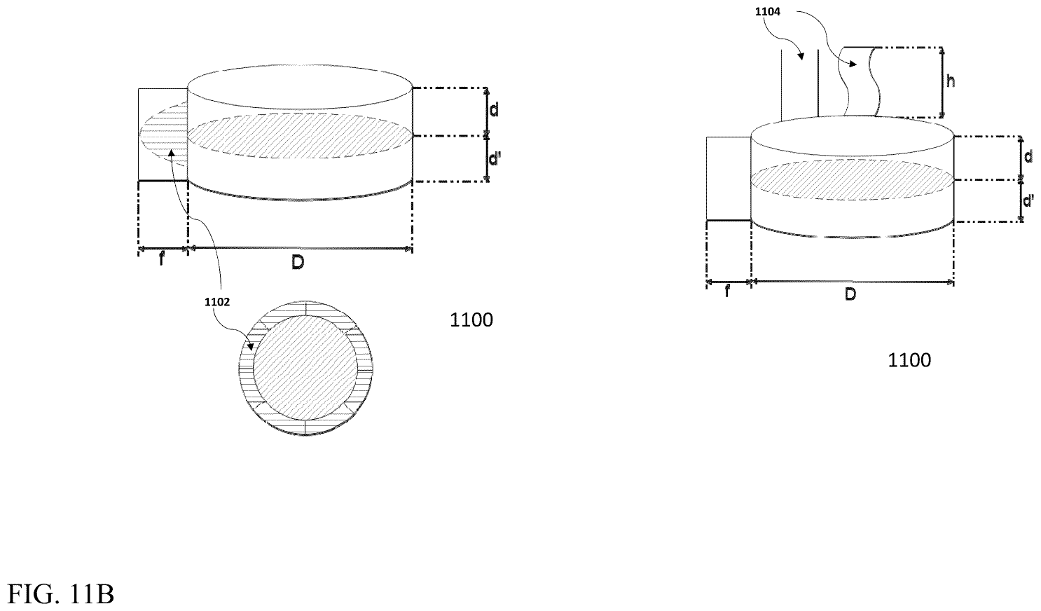

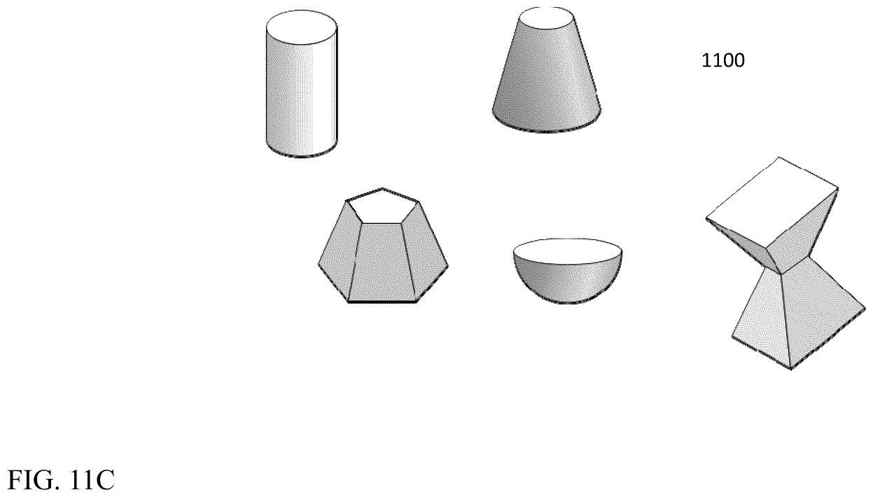

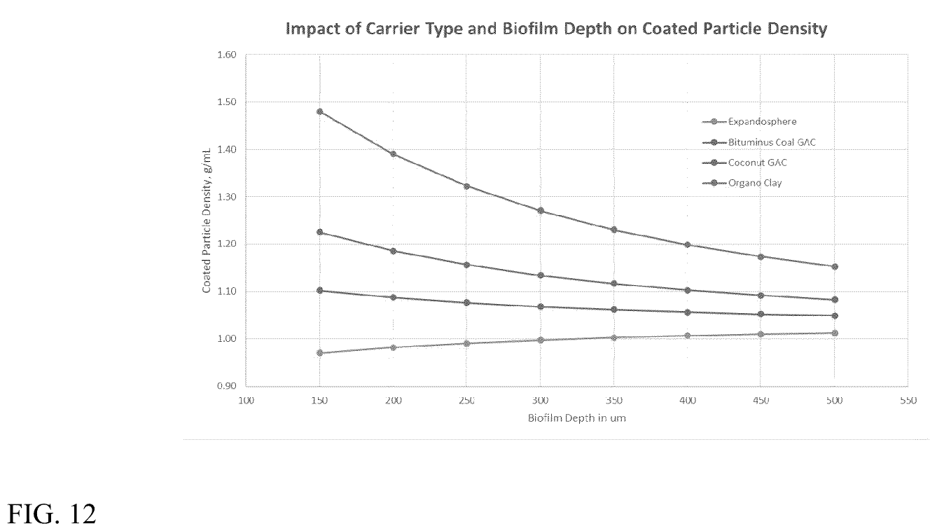

FIG. 3A represents application options for the proposed biological reactor or process (100) as a suspended biological treatment (example embodiment), with an inlet (111) and an outlet (112), that includes a reactor tank(s), zone or multiple zones, separated in reaction space or reaction time (118), and an optional solids liquid separation (113) based on settling or clarification or floatation or filtration (single or multiple in series or parallel), as applied to an industrial manufacturing process, water reclamation (including but not limited to municipal or industrial or agro-industrial water), water or biosolids reuse or drinking water production. Yet in some embodiments chamber 118 and 113 are integrated in one as is the case with sequencing batch reactors, or fluidized bed reactors or sludge blanket reactors, yet in other cases chamber 118 and 113 are separated. The ‘loose’ biofilm base stratum, structural media (may also referred as loose media), (114) that is optionally functionalized to grow reactive biofilms by colonization as further elaborated in FIG. 11 (and sub figures) and FIG. 12, can be applied optionally in the influent (111), directly into the biological reactor/process, or directly in a recycle stream, or using chamber(s) (117) located anywhere, in the inlet, outlet, or associated with recycles, for either mixing (as in a mixing chamber for conditioning or regeneration), or reaction (optional functionalized using chemical, biological or physical reactions), or for addition of a stratum. The chamber(s) can be located anywhere within the context of the reactor or the separator. The chambers, including chamber 117, can provide mixing and/or additional reactive conditions or functions (including physical, chemical or biological reactions for conditioning or regeneration or to provide for substrate lability) as needed to selectively control the process, or to inhibit or induce microorganism growth, or to actively react with the stratum such as in ion exchange reactions where cations and anions are added or removed from the substratum in the chamber or to recover or revive sorption potential using for example a thermal approach or to revive a coagulation potential, or to revive a charge potential (such as in a Fentons reaction). In many of these cases the stratum is recharged, conditioned or made reactive in this chamber 117. The chamber 117 that is used for functionalization may be located contiguous to the process or discontiguous in a separate location away from the biological reactor. In some embodiments as when during the use of the reactive stratum in chamber 118 regeneration of the functionality of the stratum occurs chamber 117 and 118 can be considered one, yet in other embodiments chamber 117 and chamber 118 are separate and with complementary reaction functions. The stratum could be applied as loose media (114) mixed into the process, or as modules, in cassettes, cages or other approaches that could allow for the media to be periodically recharged upon sufficient or full exhaustion. An example is to use hanging textiles, ropes, lace, that are placed in cassettes, or any approach that manages media surface area and biofilm thickness. The functionalization can be applied in manufacture (such as by doping, coating, cross-linking, grafting, surface enhancements or any method of affixing of desirables or removal of undesirables) as also outlined in FIG. 3A and FIG. 3D. While the functionalization during manufacture is shown in the left-hand side of FIG. 3A and FIG. 3D, it is done so for illustrative purposes only, and the intention is to assert the function being added/removed to/from the media (10) prior to its addition to the bioreactor, and as a distinct element for consideration as part of the apparatus, method or system. Mixing energy may be required to manage mass transfer resistance and thickness of biofilms on these fixed or moving structural media. The optional solid liquid separator (113) or the optional physical selector (116) is used as an approach to determine the media exhaustion or media disintegration and removed by classification, especially if the loose media is applied into the process. The physical selector (116) can be applied anywhere in the process to manage the wasting (removal) including directly in the reactor or in the underflow of a separator thus maintaining the solids residence time of media between 1 day and 10000 days. A downstream filter could be used as part of a two-step solid liquid separator (113) in conjunction for example with a clarifier to manage the selective removal of the media that escapes the clarifier but is retained by the filter. Thus, multiple selectors and separators can be used in series or parallel to achieve the retention or removal of structural media for disposition or to send to a downstream process (115) for additional reactivity or for use as structural support or edible material. The additional process (115) in plant or in ecosystem could be any natural or constructed processes including additional liquid or solids (as described in FIG. 6) reactors or processes or for culturing of organisms (including livestock or aquaculture biological reactors or processes). The chamber, the location for stratum addition or chamber for additional reactivity could be used interchangeably at any location associated with the biological reactor.

FIG. 3B is in all ways similar to FIG. 3 and represents application options of the apparatus presented in FIG. 3 when one common set of structural support is circulated between two (2) apparatus namely 100-A and 100-B. The structural support separated in the physical selector of the first apparatus 100-A, namely 120-A, is returned to the second apparatus 100-B. In turn the structural support separated in the physical selector of the second apparatus, 100-B, namely 120-B, is returned to apparatus 100-A. This type of operation enables the use of the structural support as a constituent carrier between each of the apparatus trains, for example sorbing constituents in the first apparatus, effectively removing the constituent from the liquid in the first apparatus, 100-A, and desorbing in the second apparatus, 120-B, effectively adding that constituent to the liquid of the second apparatus; or in further example, uptaking constituents in 110-A and processing said constituent in 100-B, effectively regenerating the capacity of the structural support as it moves between apparatus. This latter type of operation can be exemplified, as other examples exist, by an activated carbon support in a drinking water application where the first apparatus 100-A is the drinking water process where trace organics are sorbed in the GAC (Granular Activated Carbon) during treatment, GAC is collected in a solid liquid separator along with the treatment residuals, sludge, GAC is separated from the residuals in the physical selector, and transferred, 120-A, to the second apparatus 100-B where GAC biological regeneration takes place, GAC is separated from the liquid in the physical selector of 100-B and the stream 120-B redirected back for use to apparatus 100-A. It is worth noting in this type of operation of two apparatuses, the support added and coming from one of the apparatus into the other apparatus is a reactive support due to the reactive nature of biofilm attached to said support. So for this particular application with two apparatuses sharing a common structural support, the stratum can be reactive or non-reactive and the overall biofilm-stratum forming the structural support added to the apparatus is reactive in nature. In some embodiments the constituent removed by the structural support might be causing inhibition to the reactions in the first apparatus, 100-A, so removal of the constituent enhances kinetic reactions in said train. Yet in other embodiments the constituent transferred to the second train, 100-B, is necessary for the reactions taking place in said train and addition of the constituent is beneficial for process performance. One example the latter mode of operation is presented in FIG. 3C. FIG. 3C is in all aspects similar to FIG. 3B but illustrates an anaerobic zone in the biological process in apparatus 100-A. Exemplary anaerobic zones, as others could occur, are within a primary clarification process in a wastewater treatment plant, in the supernatant or in the sludge blanket, in a sludge thickener for primary sludge or waste activated sludge, or combined primary and waste activated sludge; or in a dedicated fermenter for sludges, or fermenter for other types of organic waste as when the plant practices co-digestion, or dedicated anaerobic sewage treatment process, or anaerobic zones in a biological process such as selectors, or anaerobic zones of biological phosphorus removal applications, or contact stabilization processes or A-B processes. It is worth noting that some of these anaerobic zones might actually have controlled oxygen addition to enhance hydrolysis and fermentation reactions. The structural support with its biofilm 120-B in FIG. 3C is directed to the anaerobic zone of apparatus 100-A where soluble organic material, an in some cases colloidal material, including but not limited to volatile fatty acids (VFA), is sorbed into the structural support and its biofilm. Removal of soluble material, including VFA, reliefs inhibition of hydrolysis and fermentation processes that could occur in the anaerobic zone furthering process kinetics. It is worth noticing that in this case the reactivity of the structural support introduced to apparatus 100-A is partially or totally associated to the biofilm present in the structural support coming from 100-B. Further biofilm will grow and detach in the apparatus 100-A due to the biological processes that occur to the support and its biofilm, further enhancing its reactivity when transferred to 100-B; in some embodiments the biofilm includes biological phosphorus removal organisms that will uptake soluble organic matter, including VFA, and store them for later use, while at the same time releasing to the liquid in 100-A anaerobic zone soluble phosphorus. The structural support is separated in the physical selector of apparatus 100-A forming stream 120-A that is directed to apparatus 100-B. Here, again, the structural support reactivity is in part or totally associated to the biofilm, so a non-reactive structural support becomes reactive due to the biofilm, and its circulation between apparatus. This is not to say that only non-reactive structural stratum can be used but both reactive and non-reactive biofilm stratums can be used in this application. In a preferred embodiment the apparatus 100-B has one or more anoxic zones, and the structural support 120-A is first incorporated into one of more of said anoxic zones. This will enable use of nitrites and nitrate present in said anoxic zone to oxidize the sorbed and stored organic compounds in the structural support, and previously sorbed in the anaerobic zone of 100-A. In some embodiments the biofilm includes biological phosphorus removal organisms and uptake of phosphorus from the liquid in the anoxic zone, or in the zone where oxidation is taking place, will occur further polishing the liquid from phosphorus and providing the electron donors for nitrite and nitrate removal. Biofilm will grow and detach and transform in 100-B apparatus and will enhance structural support reactivity for further sorption or organic matter when returned to 100-A. The structural support is separated in the physical selector of apparatus 100-B forming stream 120-B that is returned to apparatus 100-A to repeat the cycle.

FIG. 3D is a representation of FIG. 3A without a downstream reactor. The figure contains a proposed biological reactor or process (100) as a suspended biological treatment (example embodiment), with an inlet (111) and an outlet (112), that includes a reactor tank(s), zone or multiple zones, separated in reaction space or reaction time (118), and an optional solids liquid separation (113) based on settling or clarification or floatation or filtration (single or multiple in series or parallel), as applied to an industrial manufacturing process, water reclamation (including but not limited to municipal or industrial or agro-industrial water), water or biosolids reuse or drinking water production. Yet in some embodiments chamber 118 and 113 are integrated in one as is the case with sequencing batch reactors, or fluidized bed reactors or sludge blanket reactors, yet in other cases chamber 118 and 113 are separated. The ‘loose’ biofilm base stratum, structural media, (114) can be applied optionally in the influent (111), directly into the biological reactor/process, or directly in a recycle stream, or using chamber(s) (117) located anywhere, in the inlet, outlet, or associated with recycles, for either mixing (as in a mixing chamber), or reaction (optional chemical, biological or physical reactions), or for addition of a stratum. The chamber(s) can be located anywhere within the context of the reactor or the separator. The chambers, including chamber 117, can provide mixing and/or additional reactive conditions or functions (including physical, chemical or biological reactions) as needed to selectively control the process, or to inhibit or induce microorganism growth, or to actively react with the stratum such as in ion exchange reactions where cations and anions are added or removed from the substratum in the chamber or to recover or revive sorption potential using for example a thermal approach or to revive a coagulation potential, or to revive a charge potential (such as in a Fenton's reaction). In many of these cases the stratum is recharged, conditioned or made reactive in this chamber 117. The chamber 117 may be located contiguous to the process or dis-contiguous in a separate location away from the biological reactor. In some embodiments as when during the use of the reactive stratum in chamber 118 regeneration of the functionality of the stratum occurs chamber 117 and 118 can be considered one, yet in other embodiments chamber 117 and chamber 118 are separate and with complementary reaction functions. The stratum could be applied as loose media (114) mixed into the process, or as modules, in cassettes, cages or other approaches that could allow for the media to be periodically recharged upon sufficient or full exhaustion. An example is to use hanging textiles, ropes, lace, that are placed in cassettes, or any approach that manages media surface area and biofilm thickness. Mixing energy may be required to manage mass transfer resistance and thickness of biofilms on these fixed or moving structural media. The optional solid-liquid separator (113) or the optional physical selector (116) is used as an approach to determine the media exhaustion, especially if the loose media is applied into the process. The physical selector (116) can be applied anywhere in the process to manage the wasting (removal) including directly in the reactor or in the underflow of a separator thus maintaining the solids residence time of media between 1 day and 10000 days. The selected media (120) is returned to the reactor directly or through a chamber. A downstream filter could be used as part of a two-step solid-liquid separator (113) in conjunction for example with a clarifier to manage the selective removal of the media that escapes the clarifier but is retained by the filter. Thus, multiple selectors and separators can be used in series or parallel to achieve the retention or removal of structural media for disposition. The chamber, the location for stratum addition or the chamber for additional reactivity could be used interchangeably at any location associated with the biological reactor.

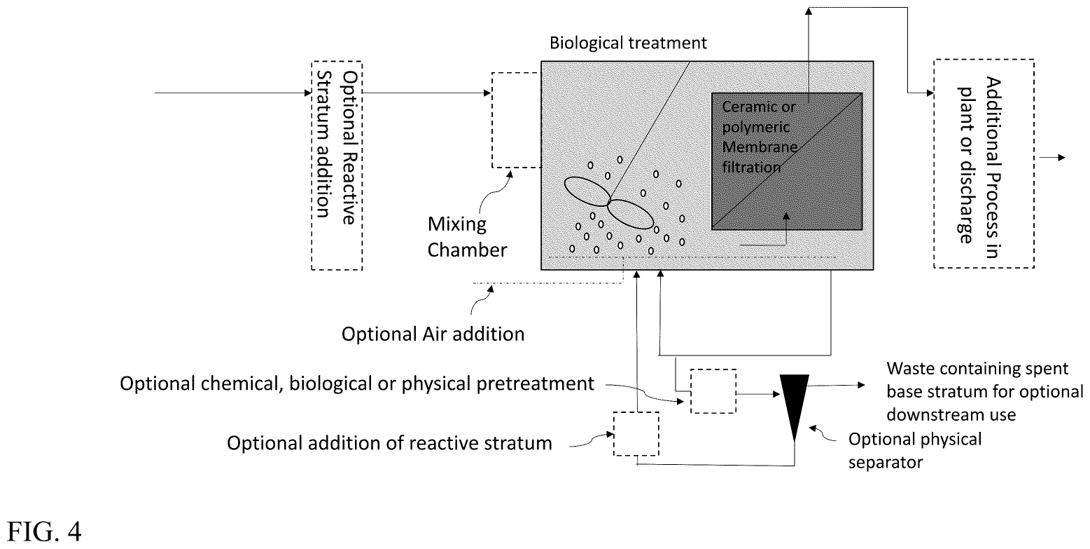

FIG. 4 represents application options similar to FIG. 3 for the proposed biological reactor/process as a suspended biological treatment example embodiment, excepting the replacement of a solid-liquid separation based on membrane separation as applied to water reclamation, water or biosolids reuse or drinking water production (all else is similar in description to FIG. 3. The biofilm base stratum can be applied optionally in the inlet, directly into the biological process or using a chamber, or directly in the recycle stream or anywhere within the context of the reactor or the separator. The chambers can provide mixing or additional reactive conditions or functions (including physical, chemical or biological reactions). The stratum could be applied as loose media mixed into the process, or as modules, cassettes, cages or other approaches that could allow for the media to be periodically recharged upon sufficient or full exhaustion. The solid-liquid separator or the optional physical selector is used as an approach to determine the exhaustion, if the media is applied directly into the process. The physical selector can be applied anywhere in the process to manage the wasting including directly in the reactor or in the underflow of a separator. Thus, multiple selectors and separators can be used in series or parallel to achieve the retention or removal of structural media for disposition or to send to a downstream process for additional reactivity or for use as structural support. The additional process in a plant or ecosystem could be any natural or constructed processes including additional liquid or solids (as described in FIG. 6) processes. The chamber, the location for stratum addition or the chamber for additional reactivity could be used interchangeably at any location associated with the biological reactor. The media can be used to reduce sludging associated with membrane separators or membrane biofilm reactors while providing reactivity features.

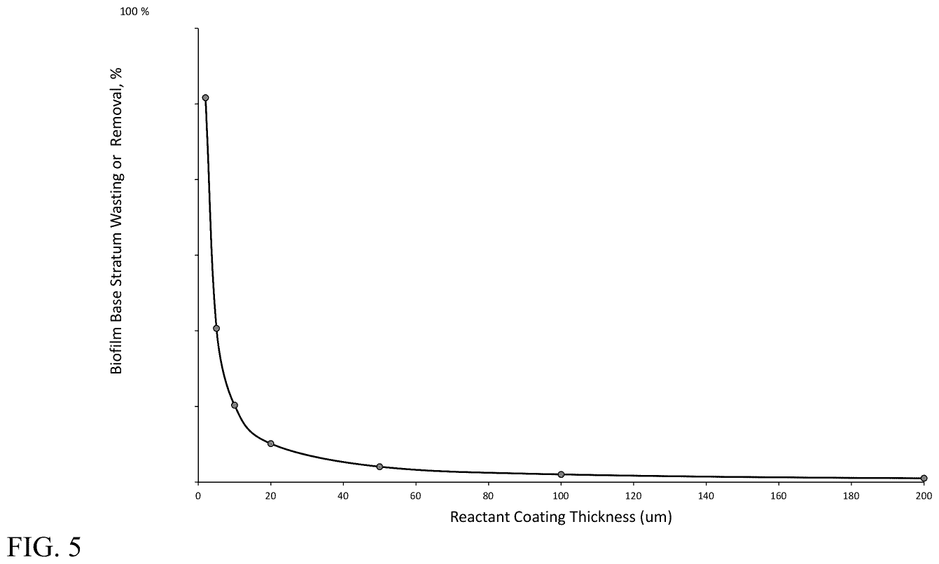

FIG. 5 shows an example representation of the impact of decreasing thickness of the reactive base stratum (as it gets consumed) on its wasting or removal from the treatment system. In this example, the stratum is retained in the system up to a certain thickness, and as it gets sufficiently thinner, it is removed using a physical separator/selector. The removal can occur based on any x-axis parameter including, but not limited to, thickness, size, volume, surface area, density/specific gravity or any changing characteristics of the media or stratum. The representation shows one possibility of removal efficiency pattern. Other patterns are also possible of any shape of a line described within the two axes shown in the figure.

FIG. 6 represents various optional downstream solids processes where the base stratum can be used for additional reactivity or realized benefits including from right to left, a fermenter, thickening or dewatering process, a thermal hydrolysis process (THP), an anaerobic or aerobic digestion process, a dewatering process. Crystallizer, stripper, washer and anammox side stream treatment processes are also shown. The location of each process can be interchanged or a process can be entirely skipped. Thermal processes (not shown), such as bio-drying, drying, pyrolysis, gasification, carbonization, liquefaction or solid digestion could be other processes for consideration for downstream use of stratum. Agro-industrial processes (not shown) are also processes for consideration where an edible stratum with biofilm is selectively routed for feed to livestock or aquatic organisms. The reactions could entail improved performance of these processes or reactors using either the residual reactivity of a single or multiple layers or from the use of the base stratum itself. A physical separator or selector could be employed to remove the stratum or a realized product.

FIG. 7 shows the use of a structural media (10) similar to FIG. 1, in this case made of biodegradable polymer/plastic, that is the base stratum, thus containing by itself a biodegradable polymer/plastic structural reactant. The biodegradable polymer/plastic (20) as an example embodiment can be either moulded, extruded or printed or produced in any manner possible and of any size, shape or density/specific gravity that could help with its reaction, mixing or selection. Multiple biofilms (30), inner, middle and outer layers are shown that are either controlled by the structural media, controlled by inner and outer biofilm layers (or their products) or redox conditions, as a symbiosis approach, and an outer biofilm that is controlled by the bulk liquid. The biofilms can be of any shape, structure, or thickness. They can be intermingled and integrated into each other. The layers are shown only as a schematic representation and an example embodiment. Upon its completed use or sufficient exhaustion, the stratum could be removed physically or optionally by a separator or selector. The reactivity could be increased or decreased using a physical, chemical or biological reaction approach external to (such as shown in FIG. 3) or within the structural media (such as using heat, or other co-reactants). The key to sustainable action is to manage the physical forces to supply it to the process for reaction, retain it in the process, to manage its biodegradation, to manage its removal, to obtain further downstream reuse or to recharge it. The physical feature, size and shape can be varied to be a part of a biofilm, or for the biofilm to be entrained in the polymer/plastic. One could have microbial communities directly controlled by the polymer/plastic stratum, microbial community controlled by the stratum and the base community, or microbial community reliant on the bulk liquid as shown in the figure. These communities could be synergistic and take advantage of co- or counter-diffusion of substrates. The production of greenhouse gases could be addressed by such management of substrates and/or micro-organisms. The wastewater or reactor fluid characteristics could help with such reactivity.

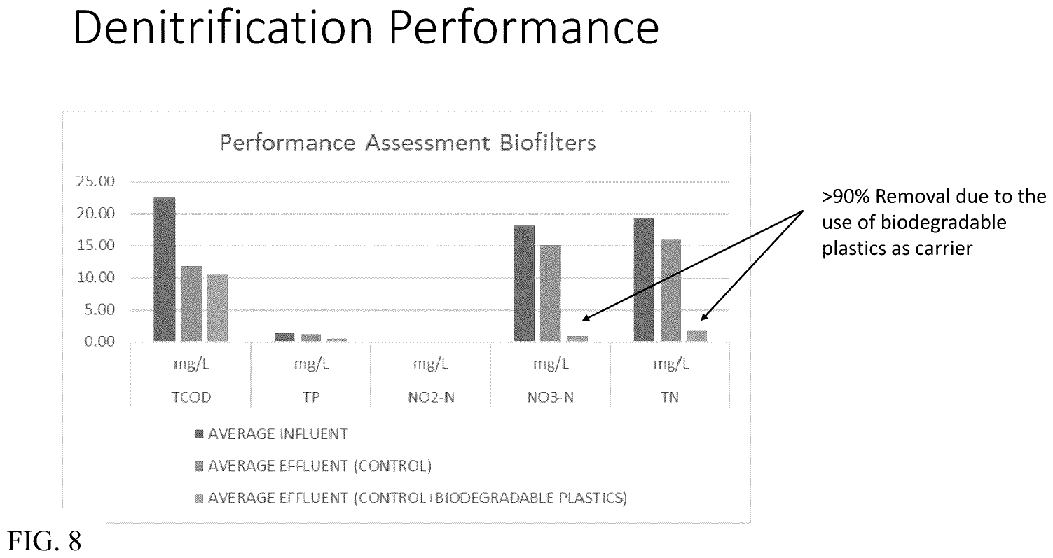

FIG. 8 shows the use of biodegradable polymers/plastics surface reactant as a carbon source for denitrification and phosphorus removal. This includes the use of such materials by organisms such as but not limited to denitrifying polyphosphate accumulating organisms, or as a co-substrate for micropollutant degradation. The material could become a host for reactions such as partial denitrification with anammox, with relevant organisms grown on such surfaces. Growth of any autotroph or heterotroph is possible on such biodegradable polymers/plastics, in a way to create relevant synergies or symbiosis associated with co- or counter diffusion of substrates. The type of biodegradable particles containing volatile fatty acids, such as propionic acid, which can selectively favor the growth of phosphorus accumulating organisms, glycogen or polyhydroxyalkanoate or other carbon storing organisms. Any specific organism can be used for any purpose in the use of such polymers/plastics as a carbon source as well as a structural stratum.

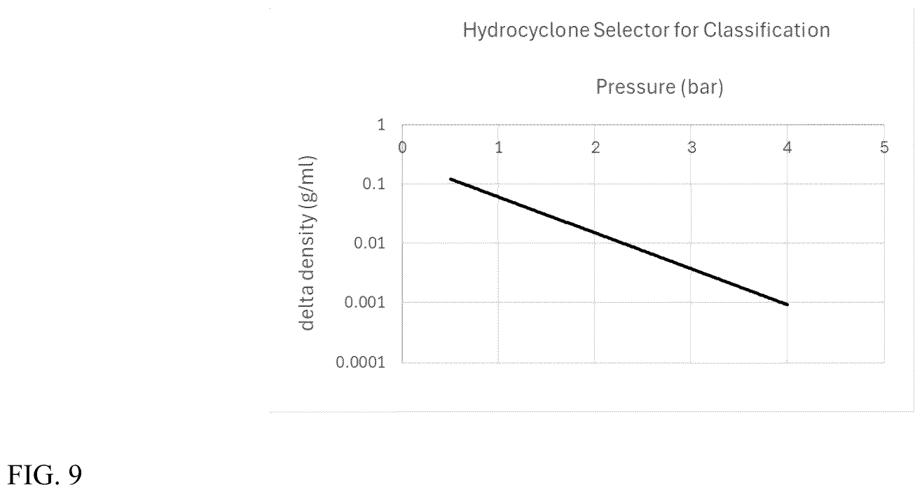

FIG. 9 shows an approach where the physical characteristics of the structural media (10) are configured to allow the structural media (10) removal using the selection (116) based on an example weight-based selector based on change in specific gravity (for a fixed size of structural media). As shown in this figure, the ability to classify based on a small change in specific gravity/density (as low as 0.001, or 0.001 g/ml density) increases as the hydrocyclone pressure is increased. The size of the hydrocyclone selector can also determine the classification efficiency. A smaller hydrocylone operating at higher pressure is able to classify better than an larger hydrocyclone operating at a higher pressure. Thus a change in specific gravity based on range of 0.005-1.0 is used as a preferred embodiment for removal of the media upon sufficient reaction or retention.

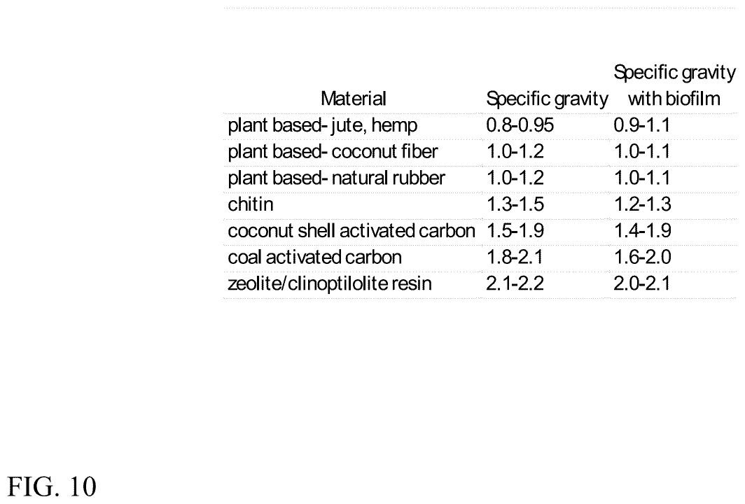

FIG. 10 links the reactive supports with different specific gravity observed. For example, media such as granular activated carbon can have specific gravity greater than 1 but less than 2. Coconut shell activated carbon has a specific gravity of 1.5-1.9. Coal based activated carbon has a specific gravity of 1.8-2.1 and can be maintained to a specific gravity of less than 2.0 when covered with biofilm. Ion exchange media can have specific gravity of 2.0 or greater. The biofilm grown typically has a specific gravity close to unity and therefore will make lighter materials heavier and heavier materials lighter. Air voids or bubbles can lower specific gravity considerably. Thus, the reactivity of such supports is linked to the natural specific gravity of such supports, ability to add voids or weighting material to such supports, and their ability to be mixed, distributed, sedimented, floated, resuspended or re-immersed to provide enhanced interaction with substrates and/or additional reaction time. To be clear, these are exemplary ranges, and other values are possible by managing the specific gravity of these materials.

FIG. 11 an exemplary embodiment of one structural media 1100 designed to control the depth of the biofilm from very thin biofilms to thick biofilms enabling different reactivities (aerobic, anoxic or anaerobic). In one embodiment, two or even three biofilm thicknesses (multiple thicknesses are possible) can be generated supporting different reactivities (anammox in anoxic and ammonia-oxidizing bacteria in aerobic. This functionality of reactive biofilms can be managed using shear, in one example embodiment, the shear-resistant autotrophic (anammox or ammonia-oxidizing bacteria or nitrite-oxidizing bacteria) reactive biofilm is retained on media relative to easily sheared-off heterotrophic biofilm. The structural media 1100 is of an exemplary prismatic shape, forming an exemplary prismatic carrier, with a main dimension D, of value 1-10 mm, and a second dimension H, of value 50 to 1000 μm, and two open walls to enable the transfer of constituents in and out of the biofilm. The prismatic carrier 1100 could be a circular prism forming a cylinder, but it could be an elliptical prism, or a square prism, or a triangle prism, or a star prism or a diamond prism, or any other shape used to form the prism as illustrated in 1103 and FIG. 11C. The prismatic carrier 1100 could be a right prism or an oblique prism, and yet an optional stratum 1102 internal to the prism divides the prism in two separate chambers with depths d and d′ with one surface of each chamber open and the stratum a support for biofilm growth. The depths d and d′ determine the location of the dividing stratum and the depth of the biofilm and said dimensions d and d′ could be any fraction (0-1) of the dimension H. In some embodiments of structural media 1100 one or several optional fin(s) 1101 with a depth f of 0-1000 μm protrude(s) from the wall of the prism to further create external protected areas of controlled depth for biofilm growth. FIG. 11B further illustrates an embodiment of the prismatic structural media 1100 for controlled biofilm depth where the optional stratum 1102 is further extended to the outside of the prism to further constrain and better define the protected volume where biofilm can grow. Yet in an alternative embodiment of structural media prismatic carrier 1100 additional protection for biofilm growth inside the chambers can be provided by adding optional extra fins 1104 of height h, 0-1000 μm, that restrict the hydrodynamic shear on the surface of the biofilm. FIG. 11C further illustrates exemplary alternative embodiments, as others exist, of the prismatic structural media 1100 with right prisms and oblique prisms and cup-shaped. This approach can be considered for different shapes and dimensions and structures. The exemplary figures are to show approaches for growth using different depths using such structures to expose, partially protect or fully protect from shear. The thickness of the biofilm could also be self-limiting (based on extent of substrate diffusivity and reactivity into the biofilm under different electron acceptors or donors).

FIG. 12 describes the essentials of FIG. 10 in a graphical format. Herein, the specific gravity of the overall media and biofilm is dependent on both, where the reactive biofilm is calibrated based on thickness of biofilm (as described in FIG. 11A, FIG. 11B and FIG. 11C) which depends on hydrodynamic shear. This compounded specific gravity (combination of specific gravity of media and reactive biofilm) is a function of two specific gravities. The biofilm tends to moderate the specific gravity of the media towards unity (the biofilm specific gravity is close to 1). The thicker the biofilm, the closer the specific gravity approaches unity (or in that vicinity). A self-agglutinating reactive biofilm has a specific gravity in the range of 1.01-1.07. In one embodiment a structural media made of plastic (including and not limited to high density polyethylene) is manufactured of a certain density by doping it with sufficient calcium carbonate to make it heavier to be able to grow anoxic biofilms. In this case a HDPE of specific gravity 0.94 to 0.96 is sufficiently doped with calcium carbonate to a specific gravity range of 0.97 to 0.99, to improve mixing hydrodynamics in anoxia,

FIG. 3 and FIG. 4 can also include cassettes or cages containing such media in the biological treatment zone.

The terms “including,” “comprising” and variations thereof, as used in this disclosure, mean “including, but not limited to,” unless expressly specified otherwise.

The terms “a,” “an,” and “the,” as used in this disclosure, means “one or more”, unless expressly specified otherwise.

It is noted that in this specification, wherever a description is provided in terms of thickness associated with a biofilm, the term applies equally to a biofilm mass, biofilm volume, or a biofilm density/specific gravity, but the dimensions of mass, volume or density/specific gravity will need to be appropriately proportioned, as understood by those skilled in the pertinent art. Any implementation of a biofilm can include arrangements of two or more biofilms arranged in series, in parallel, in tributary (for example, where additional flows such as a bioaugmentation, co-substrate, or micronutrient are added to a downstream reactor) or in distributary (for example, where flow from one reactor is distributed into two or multiple parallel reactors) configurations. The terms density and specific gravity, and any values proposed for density and specific gravity, herein, are used interchangeably.

The term “approach,” as used in this disclosure, means “a method or a process,” unless expressly specified otherwise.

The term biological reactor is typically an apparatus that perform biological reactions, within a biological process. The reactions can be for any purpose including treatment, reclamation or production (including culturing). Wastewater treatment and water reclamation can be used interchangeably.

Values expressed in a range format can be interpreted in a flexible manner to include not only the numerical values explicitly recited as the limits of the range, but also to include all the individual numerical values or sub-ranges encompassed within that range as if each numerical value and sub-range is explicitly recited. For example, a concentration range of “about 0.1% to about 5%” can be interpreted to include not only the explicitly recited concentration of about 0.1 wt. % to about 5 wt. %, but also the individual concentrations (for example, 1%, 2%, 3%, and 4%) and the sub-ranges (for example, 0.1% to 0.5%, 1.1% to 2.2%, and 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “wastewater,” as used in this disclosure, means “water or wastewater,” or “industrial wastewater,” or “substrate,” unless expressly specified otherwise.

The term “treatment,” as used in this disclosure, also means “reaction,” unless expressly specified otherwise.

The term “homogenizer” means any device employed to provide high shear mixing to achieve wet grinding of particles homogenizing the particle size distribution within a narrow band. A variety of commercially available equipment exist for this purpose such as but not limited to three-stage high shear in line Dispax-Reactor, or Quadro HV High Shear Homogenizer. “Homogenization” is the process of using a homogenizer in a slurry solution to obtain a narrow particle size distribution.

The term “slurry” means a watery mixture of insoluble matter in the form of particles or fibers.

The term “plant-based” means materials that are derived from multicellular eukaryotic life form of the kingdom Plantae that undergo photosynthesis for its nutrition and have absence of organs for locomotion. Some of the plant-based materials might be fibrous in nature such as, but not limited to, cotton, kapok, bamboo, flax, hemp, jute, kenaf, ramie, abaca, banana, pineapple, sisal or coir; while others are in the form of particles such as but not limited to bark, hard and soft woods, pecan shells, other nut shells, rice husk, corn cobs, coconut husk and in general grain husks.

The term optional is meant to imply that a reactor, reaction or process can either be used in different locations or if a process can be eliminated in some instances. The optional concept refers to a location or locations of a chamber (as an example) amongst multiple chamber location approaches within a Figure. The optional concept is also to provide an approach to eliminate a reactor, reaction or process (i.e. the reactor, reaction or process is not needed in some instances and therefore optional).

The term, “media”, “support”, “structural support”, “stratum” and “structural media” can be used interchangeably. These support media can be both inert or reactive based on needs. The term “strata” and “stratums” can also be used interchangeably.

All claimed features are included in the specifications as below:

An apparatus (100) comprising:
a biological reactor (110) with an inlet (111) and an outlet (112), for employing a structural media (10) having a single, multiple, blended or layered strata (20) that are fixed, suspended or moving, and carrying a single or multiple biofilms (30) of single or multiple solids residence times for the selective growth of organisms or for the removal of carbonaceous material, nutrients, inorganic compounds and/or micro-pollutants in a suspended growth process, wherein the structural media (10) is fixed, suspended or moving along with the single or multiple biofilms,
wherein a use (117), reaction (118), retention in the biological reactor (110), separation (113), selection (116) or removal (115) of the structural media (10) is based on the physical characteristics of the structural media (10) that allow for the use, reaction, retention, separation, selection or removal.

The apparatus as cited above, wherein the structural media (10) comprises at least one of:
a. inorganic or organic materials or made with inorganic carbon; or
b. silica or silicic materials; or
c. metallic materials comprising one or more of potassium, calcium, magnesium, nickel, cobalt, iron, aluminum, copper, manganese, molybdenum or zinc; or
d. biodegradable polymers/plastics; or
e. recovered byproducts of wastewater or wastewater treatment process including both organic and inorganic inert or reactive materials; or
f. metallic material is used as an intracellular or extracellular reactant for oxidation, reduction, electron transport, charge balancing or charge bridging; or
g. edible stratum.

The apparatus as cited above, wherein the single or multiple biofilm (30) comprises at least one of a bacteria, archaea or eukaryotes including algae or protists.

The apparatus as cited above, wherein the structural media (10) is configured to further employ in downstream processes for additional reactions including:
a. within a sludge stream comprising either one or more of fermentation, crystallization, digestion, thermal hydrolysis, stabilization, stripping, thickening or dewatering, drying, thermal process, or beneficial reuse is in agriculture; or
b. within a liquid stream; or
c. in a constructed process or a natural system comprising one or more of a wetland, a green infrastructure, a lagoon or a reservoir; or
d. in the ecosystem such as a lake, river, estuary, bay or a marine environment, or
e. in a livestock or aquaculture process, or
f. a second apparatus as cited above with a common circulating structural media.

The apparatus as cited above, wherein the single or multiple biofilms are retained in the structural media (10) at a higher solids residence time than a bulk suspended or fixed growth of the biological reactor (110), the media or biofilm life varying in a range between 1 day and 10000 days.

The apparatus as cited above, wherein the structural media (10) is manufactured using deposition of reactant on a solid phase, or by a three-dimensional (3D) printing, moulding, extruding, baking, coating, caking, sedimenting, chemically grafting or impregnating, spray drying, solvent evaporation, irradiation. These process can be used to add reactive functionalization to the base structural media. Other approaches to manufacture include the mere placement/positioning of functionality within the media superstructure.

The apparatus as cited above, wherein the structural media (10) are contained in an industrial wastewater treatment reactor, a high rate and contact stage, bio-adsorption reactor, an activated sludge reactor, a biofilm reactor, or a micropollutant biodegradation reactor that is used for water reclamation, or for producing potable or reuse water, or for agro-industrial production or for industrial manufacturing.

The apparatus as cited above, wherein the physical characteristics of the structural media (10) are any value between:
a. 10- and 10000-microns size for retention; or
b. 0.9 and 6.5 specific gravity for retention; or
c. 0.9 and 1.2, with a broader range of 0.45 and 2.4 specific gravity for use and reactivity; or
d. 10 and 10000 m2/m3 specific surface area for use and reactivity.

The apparatus as cited above, wherein the physical characteristics of the structural media (10) are configured to allow the structural media (10) removal using the selection (116) or separation (113) comprising one of a weight-based selector, a size-based selector, or a compressibility-based selector, or a shear based selector, including one of a lamella, a settling tank, a hydro-cyclone, a centrifuge, a classifier, a mesh, a screen, a sieve, a filter, a membrane, when the structural media has a change in:
a. density or specific gravity any value varying from 0.005 to 1.0 g/ml; or
b. particle size, any value varying from 10 and 1000 microns.

A method comprising:
a biological process that reacts or treats a flow, and employing a structural media (10) having a single, multiple, blended or layered strata that are fixed, suspended or moving, and carrying a single or multiple biofilms (30) of single or multiple solids residence times for the selective growth of organisms or for the removal of carbonaceous material, nutrients, inorganic compounds and/or micro-pollutants in a suspended growth process, wherein the structural media is fixed, suspended or moving along with the single or multiple biofilms, wherein the structural media (10) along with the single or multiple biofilms (30) are configured to at least:
a. improve the extracellular properties of the biofilm; or
b. improve the intracellular reactions within the microorganism; or
c. selects for the preferential growth of a microorganism or group of microorganisms; or
d. inhibits the growth of a microorganism or group of microorganisms; or
e. improves the structural characteristics within the biofilm; or
f. increases the reaction rates or confers strength or provides structure or function to a biofilm or the contained microorganism; or
g. improves negative or positive charge or polar or hydrophilic or hydrophobic characteristics; or
h. provides inorganic carbon or alkalinity to manage biological reactions or substrate availability; or
i. improves the removal or prevents the formation of greenhouse gases, including methane or nitrous oxide; and
wherein a use (118), reaction (117), retention in biological reactor (110), separation (113), selection (116) or removal (115) of the structural media (10) is based on the physical characteristics of the structural media (10) that allow for the use, reaction, retention, separation, selection or removal.

A method as cited above, wherein the structural media (10) comprises at least one of:
a. inorganic or organic materials or made with inorganic carbon; or
b. silica or silicic material; or
c. metallic materials comprising one or more of potassium, calcium, magnesium, nickel, cobalt, iron, aluminum, copper, manganese, molybdenum or zinc; or
d. biodegradable polymers/plastics; or
e. recovered byproducts of wastewater or wastewater treatment process including both organic and inorganic inert or reactive materials; or
f. metallic material is used as an intracellular or extracellular reactant for oxidation, reduction, electron transport, charge balancing or charge bridging; or
g. edible stratum.

The method as cited above, wherein the single or multiple biofilm (30) comprises at least one of a bacteria, archaea or eukaryotes including algae or protists.

The method as cited above, wherein the structural media (10) is configured to further employ in downstream processes for additional reactions including:
a. within a sludge stream comprising either one or more of fermentation, crystallization, digestion, thermal hydrolysis, stabilization, stripping, thickening or dewatering, drying, thermal process, or beneficial reuse is in agriculture; or
b. within a liquid stream; or
c. in a constructed process or a natural system comprising one or more of a wetland, a green infrastructure, a lagoon or a reservoir; or
d. in the ecosystem such as a lake, river, estuary, bay or a marine environment; or
e. in a livestock or aquaculture process.

The method as cited above, wherein the single or multiple biofilms are retained in the structural media (10) at a higher solids residence time than a bulk suspended growth of the biological reactor (110), the media or biofilms life varying in a range between 1 day and 1000 days.

The method of claim 11, wherein the structural media (10) is manufactured using deposition of reactant on a solid phase, or by a three-dimensional (3D) printing, moulding, extruding, baking, coating, caking, chemically grafting, sedimenting or impregnating.

The method as cited above, wherein the structural media (10) are contained an industrial wastewater treatment reactor, a high rate and contact stage, bio-adsorption reactor, an activated sludge reactor, a biofilm reactor, or a micropollutant biodegradation reactor that is used for water reclamation, or for producing potable or reuse water, or for agro-industrial production or industrial manufacturing.

The method as cited above, wherein the physical characteristics of the structural media (10) are between:
a. 10- and 10000-microns size for retention; or
b. 0.9 and 6.5 specific gravity for retention; or
c. 0.9 and 1.5 specific gravity for use and reactivity; or
d. 10 and 10000 m2/m3 specific surface area for use and reactivity.

The method as cited above, wherein the physical characteristics of the structural media (10) are configured to allow the structural media (10) removal using the selection (116) or separation (113) comprising one of a weight-based selector, a size-based selector, or a compressibility-based selector, or a shear based selector including one of a lamella, a settling tank, a hydrocyclone, a centrifuge, a classifier, a mesh, a screen, a sieve, a filter, a membrane, when the structural media has a change in:
a. Density, any value varying from 0.005 to 1.0 g/ml; or
b. particle size, any value varying from 10 and 1000 microns.

What is claimed is:

1. An apparatus (100) comprising:
a suspended growth biological reactor (110) with an inlet (111), an outlet (112), and an optional separator (113);
a selector (116);
a structural media (10) having a single, multiple including interlaced, comingled or integrated, blended, or layered strata (20) that are fixed, suspended or moving; and
a functionalization of structural media (10) or biofilm (30);
wherein the functionalization of structural media or biofilm enables the structural media to be reactive or have reactive properties from carrying a single or multiple biofilms of single or multiple solids residence times for selective growth of organisms or for removal of carbonaceous material, nutrients, inorganic compounds or micro-pollutants in a suspended growth process, wherein the functionalization is added to the structural media during manufacturing, during conditioning (pre-, insitu- or post-conditioning), during regeneration (such as for activated carbon or ion exchange), or introduced by the type of biofilm created by the shape of media or shear induced to produce the relevant reactive biofilm, and
wherein a physical characteristic of specific gravity of the structural media obtained by functionalization is in the range of 0.45 to 2.4 configured for reactivity and sufficient retention so as to not be over buoyant or over heavy or with the ability to be resuspended or re-immersed upon sedimentation or floatation, for improved reactivity by enhancing mixing profiles and distribution, or for improved reactivity by promoting settlement or floatation and thereafter resuspension or re-immersion of contents within the biological reactor, and the selector (116) is configured to classify and remove the structural media by selection- or separation when the structural media has a change in specific gravity between 0.005 and 1.0, or change in particle size, between 10 and 1000 microns, and direct the removed structural media from the biological reactor to the downstream reactor for downstream processing, wherein the structural media (10) along with the single or multiple biofilms (30):
a. enables improved extracellular properties of the biofilm; or
b. enables improved intracellular reactions within a microorganism; or
c. selects for the growth of a microorganism or group of microorganisms; or
d. inhibits the growth of the microorganism or group of the microorganisms; or
e. enables improved structural characteristics within the biofilm; or
f. enables increased reaction rates or confers strength or provides structure or function to the biofilm or the microorganism; or
g. enables improved or provides ion exchange, negative or positive charge or polar or hydrophilic or hydrophobic characteristics; or
h. provides inorganic carbon or alkalinity to manage biological reactions or substrate availability; or
i. sorbs and retains constituents from the liquid; or
j. enables improved nutritional qualities of an edible support; or
k. enables improved removal or prevents the formation of greenhouse gases, including methane or nitrous oxide.

2. The apparatus of claim 1 wherein the structural media (10) comprises at least one of:
a. inorganic or organic materials including plant derived or made with inorganic carbon; or
b. silica or silicic materials; or
c. metallic materials comprising one or more of potassium, calcium, magnesium, nickel, cobalt, iron, aluminum, copper, manganese, molybdenum or zinc; or
d. biodegradable polymers/plastics; or
e. recovered byproducts of wastewater or wastewater treatment process including both organic and inorganic inert or reactive materials, or
f. metallic material is used as an intracellular or extracellular reactant for oxidation, reduction, electron transport, charge balancing or charge bridging;
g. ion exchange material; or
h. edible materials.

3. The apparatus of claim 1, wherein the single or multiple biofilms (30) comprises at least one of a bacteria, archaea or eukaryotes including algae or protists, or, wherein the reactivity of the structural media is due all or in part to the reactivity of the biofilm.

4. The apparatus of claim 1 wherein a reaction, regeneration or conditioning chamber 117 is added, and used including for:
a. enhanced regeneration of the ion exchange reactivity or activated carbon reactivity of the structural media (10) by chemical reaction;
b. improved reactivity of pollutant using an oxidant or, reductant
c. improved reactivity of substrates including pollutant by adding or removing an acid or adding or removing an alkali
d. conditioning at least one structural media into water forming a water-structural media-slurry, mixing the water-structural media-slurry or removing undesired coatings, voids or bubbles from the media

5. The apparatus of claim 1, wherein the reactor 110 or the downstream reactor 115 is an aquaculture reactor or livestock culturing facility or a feedstock production facility and the structural media is directed either from the physical selector 116, or from effluent 112 when optional solid liquid separator 113 is present or not present; or
wherein the downstream processing include:
a. within a sludge stream comprising either one or more of fermentation, crystallization, digestion, thermal hydrolysis, stabilization, stripping, thickening or dewatering, drying or thermal process; or
b. within a liquid stream; or
c. in a constructed process or a natural system comprising one or more of a wetland, a green infrastructure, a lagoon or a reservoir; or
d. in an ecosystem selected from a lake, river, estuary, bay or a marine environment

6. The apparatus of claim 1, wherein one or more types of structural media of two or more different sizes or density, such that the smaller size or density pass through the selector 116 more quickly than the larger size and density that are retained, with each of the different size or density media with a different retention time within the system 100.

7. The apparatus of claim 1, wherein the biological reactor is selected from an industrial wastewater treatment reactor including industrial aquaculture or industrial livestock production or processing, a high rate and contact stage, bio-adsorption reactor, an activated sludge reactor, a biofilm reactor, or a micropollutant biodegradation reactor that is used for water reclamation, or for producing potable or reuse water or for industrial manufacturing.

8. The apparatus of claim 1, wherein physical characteristics of the structural media (10) are
a. between:
10- and 100000-microns size for retention; or
10 and 10000 m2/m3 specific surface area for reactivity.
b. defined by the geometric dimensions of a prismatic carrier 1100 designed to control biofilm depth and the geometric dimensions of said carrier are: D from 1-10 mm, H from 50 to 1000 μm, f from 0 to 1000 μm, d and d′ a fraction 0 to 1 of H, and h 0 to 1000 μm.

9. The apparatus of claim 1, wherein the selector is selected from one of a weight-based selector, a size-based selector, a compressibility-based selector, or a shear-based selector, including one of a lamella, a settling tank, a hydrocyclone, a centrifuge, a classifier, a mesh, a screen, a sieve, a filter, a membrane.

10. A system comprising two (2) apparatus of claim 1, wherein a first apparatus 100-A and a second apparatus 100-B, with a shared structural media circulating between the two apparatus and the structural media separated in the selector of 116 of the first apparatus, 120-A, is returned to the second apparatus, and the structural media separated on the selector 116 of the second apparatus, 120-B, is returned to the first apparatus.

11. The system of claim 10, wherein the first apparatus has at least one anaerobic zone and the second apparatus has at least one anoxic zone and the shared circulating structural media is preferentially directed from the first apparatus to an anoxic zone of the second apparatus.

12. A method comprises steps of:
introducing an influent for a biological process
suspending a structural media in the biological process for reaction and use in the biological process, wherein the reaction and functionalization is provided by the structural media or by the single or multiple biofilm carried on the structural media for removal or consumption of carbonaceous material, nutrients, inorganic compounds or micro-pollutants in the influent, wherein a physical characteristic of specific gravity of the structural media is in the range of 0.97 to 0.99 configured for biofilm reactivity so as to not be over buoyant or over heavy for improved biofilm reactivity by enhancing hydrodynamics, mixing profiles and distribution, or for improved biofilm reactivity by promoting settlement of media and thereafter resuspension of contents within the biological reactor, the physical characteristic is achieved through inclusion or doping of weighting material, retaining the suspended structural media based on size or specific gravity of the structural media using a classifier or a solid-liquid separation device.
he biofilm.

13. A method comprises steps of:
introducing an influent for a biological process
suspending a structural media in the biological process for reaction and use in the biological process, wherein the reaction and functionalization is provided by the structural media or by the single or multiple biofilm carried on the structural media for removal or consumption of carbonaceous material, nutrients, inorganic compounds or micro-pollutants in the influent, wherein a physical characteristic of specific gravity of the structural media is in the range of 0.45 to 2.4 configured for reactivity and/or sufficient retention so as to not be over buoyant or over heavy for improved reactivity by enhancing mixing profiles and distribution, or for improved reactivity by promoting settlement (and thereby as an example embodiment to allow for additional reaction time) or floatation (and thereby as an embodiment to remove pollutants) and thereafter resuspension or re-immersion of contents within the biological reactor, the physical characteristic is achieved through inclusion or removal of air bubbles, pores or cavities, or weighting material, or by a three-dimensional (3D) printing, moulding, extruding, doping, baking, coating, chemically grafting, cross-linking, caking, sedimenting, spray drying, solvent evaporation, irradiation or impregnating in manufacturing of the structural media, wherein the functionalization is added to the structural media during manufacture, during conditioning (pre-, insitu- or post-conditioning), during regeneration (such as for activated carbon or ion exchange), or introduced by the colonization of type of biofilm created by the shape of media or introduced shear to produce the relevant reactive biofilm;
retaining or removing the suspended structural media by a classifying selector based on size or specific gravity of the structural media, wherein the selector classifies to remove the structural media by selection or separation when the structural media has a change in density or specific gravity, any value varying from 0.005 to 1.0 g/ml; or particle size, any value varying from 10 to 1000 microns;

14. The method of claim 13, wherein the structural media (10) comprises:
inorganic or organic materials including plant derived, or made with inorganic carbon; or silica or silicic material; or
metallic materials comprising one or more of potassium, calcium, magnesium, nickel, cobalt, iron, aluminum, copper, manganese, molybdenum or zinc; or
biodegradable plastics; or
recovered byproducts of wastewater or wastewater treatment process including both organic and inorganic inert or reactive materials; or
metallic material is used as an intracellular or extracellular reactant for oxidation, reduction, electron transport, charge balancing or charge bridging; or
ion exchange material or activated carbon material; or
edible materials.

15. The method of claim 13, wherein the single or multiple biofilm (30) comprises at least one of a bacteria, archaea or eukaryotes including algae or protists.

16. The method of claim 13, wherein the structural media or biofilm life varying in a range between 1 day and 10000 days or, wherein structural media or biofilm life of two or more different sizes is used, one that passes more rapidly through the selector and one that is retained in the selector, each size media with a different retention time between 1 day and 10000 days.

17. The method of claim 13 wherein a reaction, regeneration or conditioning process is added, and used including for:
a. enhanced regeneration of the ion exchange reactivity or activated carbon reactivity of the structural media (10) by chemical reaction;
b. improved reactivity of substrates including pollutants using an oxidant or; a reductant
c. improved reactivity of substrates including pollutants by adding or removing an acid or adding or removing an alkali
d. conditioning at least one structural media into water forming a water-structural media-slurry, mixing the water-structural media-slurry, removing undesired coatings, voids or bubbles from the media or imparting functions including adding coatings to the media.

18. The method of claim 13, wherein the biological process is selected from an industrial wastewater treatment process, a high rate and contact stage process, bioadsorption process, an activated sludge process, a biofilm process, or a micropollutant biodegradation process that is used for water reclamation, or for producing potable or reuse water or for industrial manufacturing or an aquaculture process, or a livestock process or a feedstock manufacturing process.

19. The method of claim 13, wherein physical characteristics of the structural media (10) are
a. any a value between:
10 and 100000-microns size for retention; or
10 and 10000 m2/m3 specific surface area for use and reactivity; or
b. defined by the dimensions of a prismatic carrier 1100 designed to control biofilm depth and the geometric dimensions of said carrier are: D from 1-10 mm. H from 50 to 1000 μm, f from 0 to 1000 μm, d and d′ a fraction 0 to 1 of H, and h 0 to 1000 μm

20. The method of claim 13, wherein the selector is selected from comprising one of a weight-based selector, a size-based selector, a compressibility-based selector, or a shear-based selector including one of a lamella, a settling tank, a hydro-cyclone, a centrifuge, a classifier, a mesh, a screen, a sieve, a filter, a membrane.
